(19) United States
(12) Patent Application Publication
(10) Pub. No.: US 2026/0113156 A1
(43) Pub. Date: Apr. 23, 2026

(54) METHODS, ARCHITECTURES, APPARATUSES AND SYSTEMS FOR NEAR-FIELD UPLINK MULTIPLE INPUT MULTIPLE OUTPUT

(71) Applicant: InterDigital Patent Holdings, Inc., Wilmington, DE (US)

(72) Inventors: Patrick Svedman, Stockholm (SE); Afshin Haghighat, Ile-Bizard (CA); Allan Yingming Tsai, Boonton, NJ (US); Ravikumar Pragada, Warrington, PA (US); Salah Elhoushy, LaSalle (CA); Yifan Li, Conshohocken, PA (US); Moon IL Lee, Melville, NY (US)

(21) Appl. No.: 18/924,126

(22) Filed: Oct. 23, 2024

(51) Int. Cl. H04L 5/00; H04B 7/06

(52) U.S. Cl. CPC H04L 5/0048; H04B 7/06952

(57) ABSTRACT

Procedures, methods, architectures, apparatuses, systems, devices, and computer program products for near-field uplink multiple input multiple output. A wireless transmit-receive unit (WTRU) may determine one or more angles of reception of one or more reference signals (RS) transmitted by a network node in direction of the WTRU. In reply, the WTRU may transmit an indicated subset of sounding reference signals (SRS) in the direction of the network node antenna array using a corresponding set of uplink transmission beams that correspond to a beam separation. The network node may determine if the beam separation that the WTRU used was proper. Hence, the WTRU may receive an indication from the network to change, the beam separation. Based on the beam separation indication, the WTRU may change the uplink transmission beams in order to increase or decrease the beam separation, for a subsequent transmission of a subsequently indicated subset of SRS.

### BACKGROUND

The present disclosure is generally directed to the fields of communications, software and encoding, including, for example, to methods, architectures, apparatuses, systems related to near-field radio communications in wireless networks.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example radio access network (RAN) and a further example CN that may be used within the communications system illustrated in FIG. 1A;

FIG. 2 is an illustration of N Channel State Information-Reference Signal (CSI-RS) that are transmitted from an antenna array of a Transmission-Reception Point (TRP), and the corresponding exemplary received angular separation at the wireless transmit-receive unit (WTRU) receiver (Rx);

FIG. 3 is an illustration of N corresponding Sounding Reference Signals (SRS) transmitted by the WTRU and the corresponding transmitted SRS transmit (Tx) beam separation at the WTRU;

FIG. 4 is an illustration of a TRP that transmits a single CSI-RS from an antenna/sub-array, e.g., from an antenna/sub array in the TRP array center. The figure also illustrates the CSI-RS Rx angular spread at the WTRU;

FIG. 5 is an illustration of WTRU initially transmitting SRS resources with minimal SRS Tx beam separation. The set of uplink (UL) Tx beams for SRS have a proper (good, appropriate) overall direction (e.g., reference direction), but the beam separation is too small. The figure also illustrates an exemplary SRS beam separation;

FIG. 6 is an illustration of a WTRU transmitting SRS resources with proper (good, appropriate) SRS Tx beam separation, e.g., increased by the WTRU after the reception by the WTRU of a beam separation increase indication from the network;

FIG. 7 is an illustration of a TRP that transmits two CSI-RS from antennas/sub-arrays on the two edges of the TRP array. The figure also illustrates the CSI-RS Rx angular spread at the WTRU and that the WTRU may determine (may decrease/increase/adjust or set to a given value) a beam separation based on the two received CSI-RS;

FIG. 8 is a flow chart of a method according to an embodiment, implemented by a WTRU; and

FIG. 9 is a flow chart of a method according to an embodiment, implemented by a network node.

### DETAILED DESCRIPTION

### Abbreviations and Acronyms

5GS 5G System
AoA Angle of Arrival
AoD Angle of Departure
BWP Bandwidth Part
CSI Channel State Information
CSI-RS CSI-Reference Signal
DCI Downlink Control Information
DFT Discrete Fourier Transform
DL Downlink
DMRS Demodulation RS
DoF Degree of Freedom
FF Far Field
ID Identifier(s)/Identity/Index/Indices
LOS Line Of Sight
MAC Medium Access Control
MAC-CE MAC Control Element
MIMO Multiple Input, Multiple Output
MU-MIMO Multi-User MIMO
NF Near Field
NR New Radio
NZP-CSI-RS Non-Zero Power CSI-RS
PBCH Physical Broadcast Channel
PDCCH Physical DL Control Channel
PDSCH Physical DL Shared Channel
PUCCH Physical UL Control Channel
PUSCH Physical UL Shared Channel
PRACH Physical Random-Access Channel
QCL Quasi-Colocation
RAN Radio Access Network
RAT Radio Access Technology
RB Resource Block
RE Resource Element
RIS Reconfigurable Intelligent Surface
RRC Radio Resource Control
RS Reference Signal
Rx Reception/Receive
SNR Signal-to-Noise Ratio
SRI SRS Resource Indicator
SRS Sounding Reference Signal
SS Synchronization Signal
SSB SS Block
SU Single User
TCI Transmission Configuration Indication
TRP Transmission-Reception Point
Tx Transmission/Transmit
UE User Equipment
UL Uplink
ULA Uniform Linear Array
UPA Uniform Planar Array
WTRU Wireless Transmit-Receive Unit

### Terminology

### Antenna

The term antenna may refer to an antenna element, e.g., a physical antenna element. It may also refer to an antenna port, which may correspond to one or more antenna elements, e.g., based on virtualization.

### Array

An array may correspond to an antenna array of a TRP, a WTRU, a surface, such as a reconfigurable intelligent surface (RIS), a relay, etc. The array geometry may for example correspond to a plane, i.e., a planar array, a line, i.e., a linear array, circle, i.e., a circular array, or any other geometry.

An array may comprise uniformly spaced antennas, e.g., a uniform planar array (UPA) or a uniform linear array (ULA). Typical antenna spacings include 0.5λ and 0.8λ, wherein λ is a wavelength, but antenna spacing may also be much smaller, such as in meta surfaces, or similar, or much larger, such as in large spacing arrays.

An array may comprise non-uniformly spaced antennas, e.g., uniformly spaced antennas, with a first spacing, in one or more parts of the array, and a second spacing between the parts.

### Sub-Array

An array may comprise one or more sub-arrays. A sub-array may be a part of an array, e.g., comprise one or more antennas. A sub-array typically comprises a set of adjacent antennas, in some cases even a single antenna. However, in an alternative, a sub-array may comprise a set of antennas that are not adjacent, but instead spread out in the array.

A sub-array may correspond to one or more panels. Alternatively, a panel may correspond to one or more sub-arrays.

The antennas in a sub-array may be connected to one or more radio transmitters (transmitter chains), radio receivers (receiver chains), and/or radio transceivers (transmitter and receiver chains).

The antennas in a sub-array may be connected to one radio transmitter, receiver, and/or transceiver, e.g., in the case of partially connected hybrid beamforming architecture. The antennas in a sub-array may be connected to multiple radio transmitters, receivers, and/or transceivers, e.g., in the case of fully or partially connected hybrid beamforming architecture.

Each antenna may be connected to a transmitter, receiver, and/or transceiver, e.g., in the case of digital beamforming architecture. In this case, a sub-array may comprise a single antenna. Alternatively, a sub-array may comprise multiple antennas, even all antennas in the array, and therefore may correspond to multiple transmitters, receivers, and/or transceivers.

A sub-array may comprise uniformly or non-uniformly spaced antennas. The spacing between adjacent sub-arrays may be the same as or different than the spacing between antennas within the sub-array. Different sub-arrays may use the same or different antenna spacing. In some arrays, adjacent sub-arrays are separated by a significantly larger distance than the antenna spacing within a sub-array, e.g., by many wavelengths, e.g., tens or hundreds of wavelengths. Such a design may be beneficial since it has a large array aperture while having a limited number of antennas.

Near field

The near field of an array may correspond to an area, a space, or a set of locations. The near field may be a space within a distance from the array, wherein the distance may depend on the angle from the array.

For example, the near field of an array is where the planar wave approximation (e.g., as used in the Far Field (FF)) is not sufficiently accurate, wherein the sufficient accuracy may depend on the scenario, application, use case, etc. In one example often used, sufficient accuracy may correspond to a phase error due to the planar wave approximation that is not greater than π/8.

In some cases, the near field of an array is where the gain of a beamformer (beamforming gain) drops below a certain level from its maximum. The beamformer may be based on the assumption that the planar wave approximation is valid, in which case the beamformer may give the maximum gain in a certain angle. Such a beamformer and corresponding beam may be called a FF beamformer and FF beam. The term beam is discussed in more detail below. An example of FF beamformer is a column from a discrete Fourier transform (DFT) matrix. The region within which the FF beamforming gain drops below a certain level is sometimes called the focus region. In other words, the term near field may refer to the focus region.

Within the focus region, the array may generate spot beams for transmission and/or reception. Sometimes, transmission or reception of a spot beam is called beam-focusing (or beamfocusing). A spot beam may have a distance-dependent beamforming gain, or beamfocusing gain. For example, the maximum beamfocusing gain is obtained at a particular angle and distance from the array, sometime called the focus point. Beamfocusing gain no less than X dB (e.g., 3 dB) below the maximum may be obtained within an area or space around the focus point. This area or space is sometimes referred to as the spot beam.

Whether a second array is in the near field of a first array may depend on various properties of the first and second array, such as the aperture, array orientation, relative orientation between the first and second array, distance between the array centers, considered wavelength, etc.

In some cases, a WTRU array may be in the near field of a TRP array, while the TRP is not in the near field of a WTRU array. In other cases, a WTRU array may be in the near field of a TRP array, while the TRP is in the near field of the WTRU array. In some cases, perhaps rarer, a TRP array may be in the near field of a WTRU array while the WTRU array is not in the near field of the TRP array.

### CSI-RS

The term channel state information reference signal (CSI-RS) may for example refer to one or more CSI-RS resource(s) or one or more antenna ports of one or more CSI-RS resources, wherein a CSI-RS resource may be a non-zero power CSI-RS resource (NZP-CSI-RS resource). CSI-RS may also more generally refer to a downlink (DL) RS, and/or an antenna port thereof, such as a synchronization signal (SS) and physical broadcast channel (PBCH) block (SS/PBCH block or SSB), physical DL control channel (PDCCH) demodulation RS (DMRS), physical downlink shared channel (PDSCH) DMRS, etc.

### SRS

The term sounding reference signal (SRS) may for example refer to one or more SRS resource(s) or one or more antenna ports of one or more SRS resource(s). It may also more generally refer to an uplink (UL) RS, and/or an antenna port thereof. UL RS or SRS may refer to physical uplink control channel (PUCCH) DMRS, physical uplink shared channel (PUSCH) DMRS (or DMRS antenna port or layer), physical random access channel (PRACH), etc.

### Beam

A transmitter or receiver with multiple antennas may use the antennas to form, or to generate, a transmit (Tx) or receive (Rx) beam.

The term beam may for example refer to a spatial domain filter, e.g., a WTRU spatial domain filter. For instance, a DL Rx beam may refer to a spatial domain receive filter at the WTRU, while an UL Tx beam may refer to a spatial domain transmit filter at the WTRU.

A beam may correspond to a set of phase and/or amplitude shifts applied to a radio frequency (RF) signal prior to signal transmission from one or more antennas or after signal reception from one or more antennas, e.g., analog or hybrid beamforming. A phase shift may be implemented using a time delay.

A Tx beam may correspond to a precoder, e.g., a vector or matrix, that maps information or reference symbols or signals to transmitter chains. An Rx beam may correspond to a combiner or receiver filter, e.g., a vector or matrix, that maps signals, e.g., in a digital baseband domain, from receiver chains to representations of information or reference symbols. This may be called digital or hybrid beamforming.

A transmitter may transmit different beams using different reference signals, and/or antenna ports. Hence, a beam may correspond to an effective channel, e.g., the channel experienced by a reference symbol transmitted through a beam, radio channel, etc. Consequently, a beam set may correspond to a channel matrix, or effective channel matrix. The matrix may have a rank, a condition number, etc. Depending on the beam set, the matrix may have different rank, condition number, etc. The beam set rank and beam set condition number may correspond to a matrix rank and condition number, respectively, for a beam set. As beams may correspond to vectors or matrices, beam cross-correlation may be defined as the cross-correlation between the corresponding vectors or matrices.

### Beam Direction

A Tx beam may have the highest power gain (beamforming gain) in a certain angular direction (e.g., in relation to the transmit array). In other directions, the gain is lower. Similarly, an Rx beam may correspond to the highest gain or sensitivity (beamforming gain) in a certain angular direction (e.g., in relation to the receive array). The beam direction of a beam may be the direction(s)/angle(s) in which the beamforming gain is the highest.

The directions/angles with high gain around the beam direction, e.g., within X dB (e.g., X=3) of the maximum gain, is often called the main lobe of the beam. Other directions/angles with substantial gains are often called side lobes.

A beam generated from phase shifts in the RF domain, e.g., analog/hybrid beamforming, may have a beam direction. A beam generated from precoding in baseband, e.g., digital/hybrid beamforming, may also have a beam direction.

Note that a beam direction may be frequency dependent. The beam direction may change gradually over frequency, e.g., in the case of analog/hybrid beamforming, sometimes referred to as beam squint. The beam directions on different frequencies may also be completely different, e.g., in the case of frequency dependent precoding in baseband.

A beam direction of a Tx beam may correspond to an angle-of-departure (AoD). A beam direction of an Rx beam may correspond to an angle-of-arrival (AoA).

A WTRU may be capable of generating a finite number of beam directions. The resolution of the beam directions may be different for different directions. For example, in a first direction, the angular beam resolution may be finer than the angular beam resolution in a second direction. This effect may be a result of the WTRU implementation, e.g., the antenna array geometry, transmitter architecture (e.g., analog beamforming, fully connected hybrid, partially connected hybrid, digital beamforming/precoding, etc.), RF phase shifter resolution, baseband precoding resolution, etc.

A WTRU capable of simultaneous transmission of multiple UL transmissions, e.g., multiple simultaneous UL Tx beams, may be capable of a first beam direction resolution if the beams are not transmitted simultaneously, and a second beam resolution if the beam are transmitted simultaneously.

### Beam Correspondence

A beam corresponding to a DL RS, e.g., CSI-RS, may refer to a DL Rx beam a WTRU used to receive the DL RS. A beam corresponding to an UL RS or UL channel may refer to an UL Tx beam a WTRU uses to transmit the UL RS/channel.

An UL Tx beam may correspond to a DL Rx beam, for instance for a WTRU that supports DL/UL beam correspondence. The UL Tx beam may have the same or similar beam direction as the corresponding DL Rx beam.

### DL/UL Reciprocity

In various scenarios, the UL channel, e.g., effective channel, may be determined, e.g., by the WTRU, from the estimated DL channel, wherein the DL channel may be estimated from one or more received CSI-RS. For instance, the WTRU may determine the UL channel directly from the estimated DL channel, e.g., the baseband channel between an antenna port (at the network side) and a WTRU antenna is assumed to be the same in the DL and UL. The effective channel may include effects from the radio channel as well as effects from transmitter and/or receiver hardware, etc.

### Beam Separation

A beam set, e.g., a set of Tx beams, generated by an array, e.g., an array of a WTRU, may correspond to a beam separation. Different beam sets may correspond to the same or different beam separations. Other terms may be used instead of beam separation, such as beam spread, beam span, beam range, etc.

The beam separation may be based on the beam directions of the beams in the beam set. For any pair of beams in a beam set, there may be an angle between the beam directions of the pair of beams. For example, the beam separation of a beam set may correspond to the maximum angle between the directions of any pair of beams in the set. In another example, the beam separation of a beam set may correspond to a beam separation between one or more pairs of adjacent beams, wherein the adjacency may be based on the beam directions, for instance a maximum, minimum, or average, beam separation among pairs of adjacent beams in a beam set.

The beam separation may be based on all beams in a beam set. The beam separation may be based on the power distribution in the angular domain of the beam set, e.g., a distribution of transmit power accumulated (aggregated) across the beams in the set, or an envelope (e.g., max) power across the individual beams in the set. The beam set power in a direction/angle may be based on the combined power of the beams in the beam set in the direction/angle. Note that beams in a beam set may be transmitted in the same or difference time instants, e.g., symbols. Beams in a beam set may correspond to the same or different RS. For instance, an SRS in a set of SRS may be transmitted using a beam, and a set of SRS may be transmitted using a beam set, e.g., with one-to-one mapping between SRS and beams. Also note that beam separation may be considered in the far field of the array or in the near field of the array, e.g., at one or more (near-field) distance(s) from the array.

An angular range may be represented by a part of a sphere surrounding the array at the center of the sphere. For instance, a beam separation or angular range may correspond to a circle on the sphere. The beam separation may, for instance, be quantified by the angle, from the perspective of the array, corresponding to the diagonal or the radius of the circle.

In an example, a beam separation may correspond to an angular range (or angle) that includes a certain ratio of the total power, e.g., total Tx power for the beam set, such as 50% of the power. For example, the beam separation corresponds to the smallest circle on the sphere that includes the ratio of the power.

In another example, a beam separation may correspond to an angular range, e.g., the smallest angular range, that includes all angles with a corresponding power, or power density, (in an angular power distribution) above a certain power level, e.g., X dB (e.g., X=3) below the maximum power (in the angular power distribution). For example, the beam separation corresponds to the smallest circle on the sphere that includes all angles with a power above the power level.

Beam separation may correspond to a beam separation around a direction, e.g., beam direction. The maximum angle, etc., may determined from the direction, e.g., by centering the direction in the considered angular range, or by setting the direction as an edge of an angular range.

In some cases, a beam set may correspond to multiple beam separations, such as a beam separation in a first angular dimension, e.g., horizontal, and a beam separation in a second angular dimension, e.g., vertical.

In some cases, a beam set may roughly correspond to different directions along a first angular dimension, while roughly the same direction along a second angular dimension. The beam separation may correspond to a beam separation in the first angular dimension.

In some cases, a beam set may roughly correspond to different directions along a first angular dimension, and different directions along a second angular dimension. There may be a first beam separation corresponding to a beam separation in the first angular dimension and a second beam separation corresponding to a beam separation in the second angular dimension, e.g., when the beam directions fall on, or within, an oval, or a rectangle, or similar, in a two-dimensional angular plane.

Alternatively, there may be a beam separation that corresponds to both angular dimensions. For instance, a WTRU may generate a beam set with roughly the same beam separation in both angular dimensions, e.g., when the beam directions fall on, or within, a symmetric shape, such as a circle or a square, or similar, in a two-dimensional angular plane.

Even when the beam directions of a beam set are not symmetric and the first beam separation in a first angular dimension may be different from the second beam separation in a second angular dimension, the beam set and/or beam directions, etc., may be represented by a single beam separation. A single beam separation may be determined from multiple, e.g., two beam separations. In an example, the average beam separation among the multiple beam separations may be determined. In another example, the maximum beam separation among the multiple beam separations may be determined.

In some cases, a single beam separation metric might not need to be determined from multiple beam separations, e.g., by an average or maximum operation. Instead, it may be sufficient to determine an order of the beam separations corresponding to different beam sets, e.g., from smaller to larger, or from smaller than or equal to larger. For example, the beam separation of a first beam set may be determined as smaller than the beam separation of a second beam set if, for the first beam set, the beam separation is smaller in at least one angular dimension, compared to the second beam set. In another example, the beam separation of a first beam set may be determined as smaller than the beam separation of a second beam set if, for the first beam set, the beam separation is smaller in at least one angular dimension and smaller than or (at least roughly) equal to in the other angular dimensions, compared to the second beam set.

### Beam Separation Level

A beam separation may be represented by a beam separation level. A beam separation level may correspond to a range of beam separations. A beam separation level may correspond to a beam separation. Beam separation levels may be used for indication, reporting, etc., of beam separation in a wireless system.

Beam separation levels may be represented by integer numbers. For example, a lowest level may be represented by 0, the second lowest level may be represented by 1, etc. A highest level may be denoted the maximum beam separation level, e.g., the max level. The number of beam separation levels may be the max level minus 1.

A beam separation level may correspond to an angle or an angular range. For instance, the level may correspond to the minimum or maximum angle between beams, or directions of beams, in a beam set or corresponding set of SRS.

In some cases, the relationship between beam separation level and beam separation is up to WTRU implementation. In other words, the WTRU and network may communicate on beam separation levels, but the WTRU might not reveal the relationship between the levels and the actual beam separation to the network. Still, since the network may be capable of measurements of network-side received beam separation, the beam separation level coordination may be beneficial. However, it may be specified and known to both WTRU and network that a lower beam separation level corresponds to smaller (or smaller or equal) beam separation, while higher beam separation level corresponds to higher (or higher or equal) beam separation.

In other cases, a relationship between beam separation levels and beam separation may be known to the network, e.g., if a relation between a beam separation level and beam separation, or a range thereof, is specified, reported by the WTRU, or configured by the network to the WTRU.

### Spatial Reference and Reference CSI-RS

The term spatial reference may for example refer to a DL RS or UL RS that the WTRU may use to determine an UL Tx beam, e.g., spatial domain transmit filter, for a transmission of an UL signal/channel, such as SRS, PUCCH, PUSCH, etc., e.g., based on beam correspondence or DL/UL reciprocity. A spatial reference may be configured and/or indicated in a spatial relation and/or a transmission configuration indicator (TCI) state, such as a joint DL/UL TCI state or a separate UL TCI state.

A CSI-RS, e.g., single-port or multi-port associated CSI-RS, may be a spatial reference for a set of SRS, e.g., a set of single-port SRS resources. The WTRU may determine UL Tx beam(s), e.g., precoders, for the set of SRS based on the CSI-RS, wherein the determination may be based on DL/UL reciprocity.

The term reference CSI-RS may refer to one or more DL RS, e.g., CSI-RS, that are configured/indicated as spatial reference, e.g., associated CSI-RS, for a set of SRS.

### ID (Id)

The term ID (Id) may correspond to one or more of identity, identities, index, indices, identifier(s), or similar, according to context.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

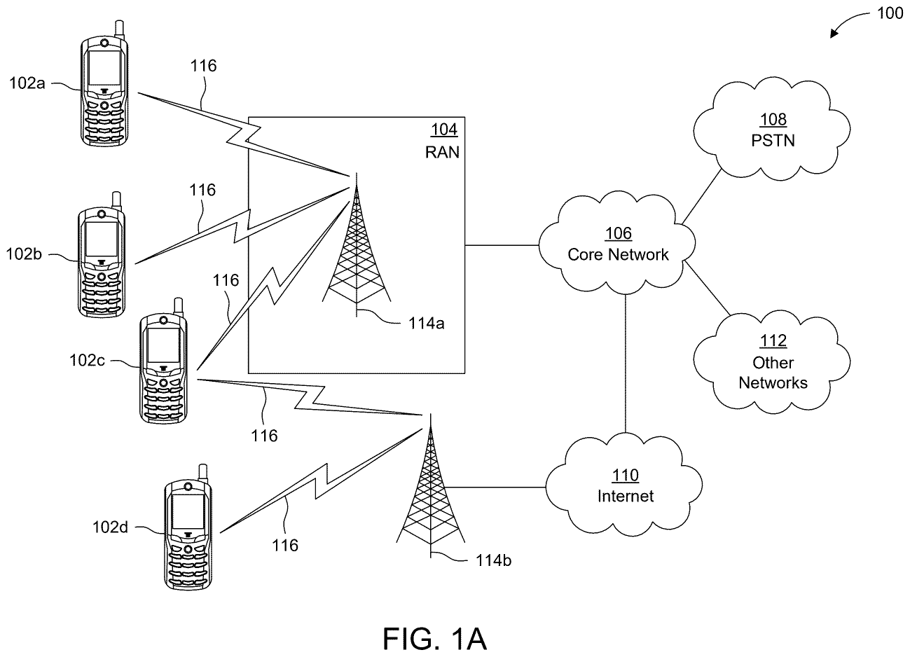

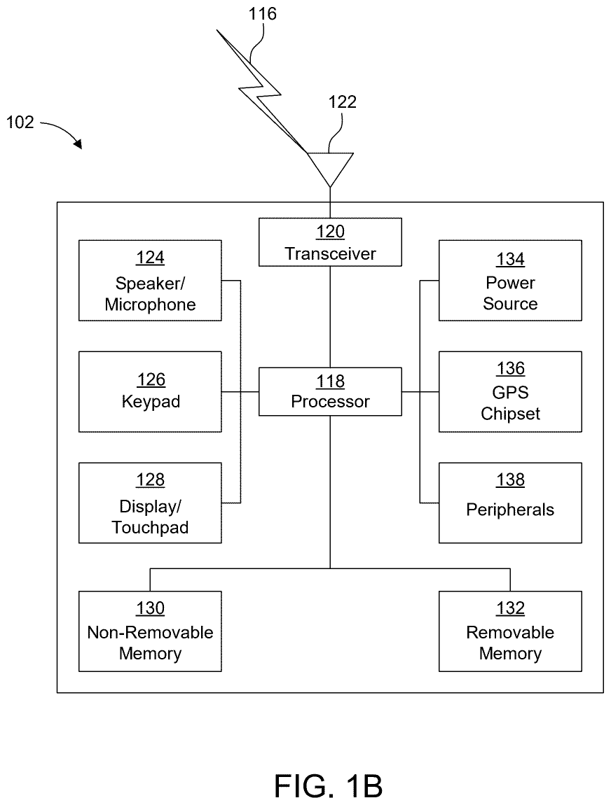

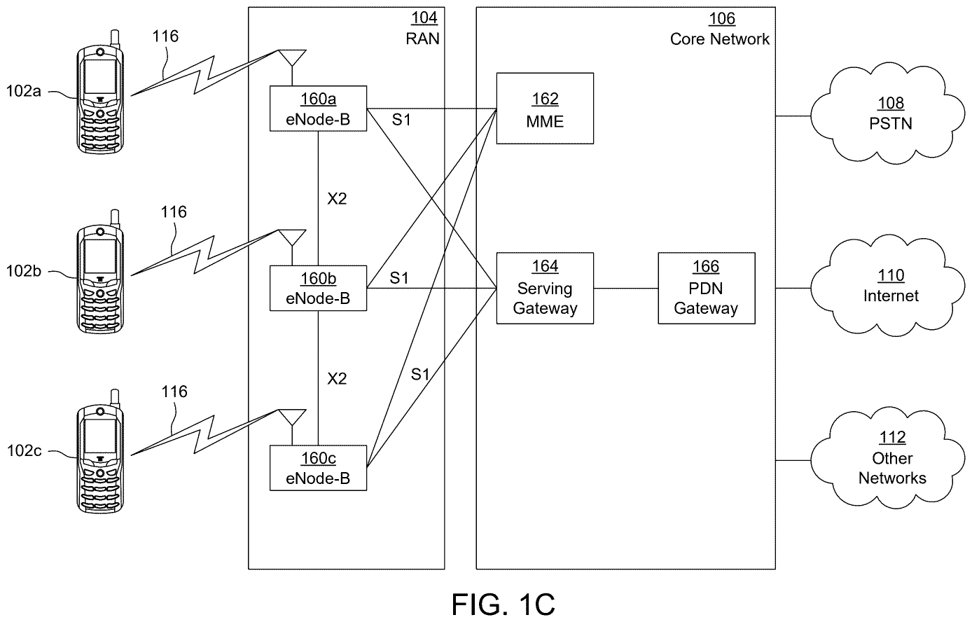

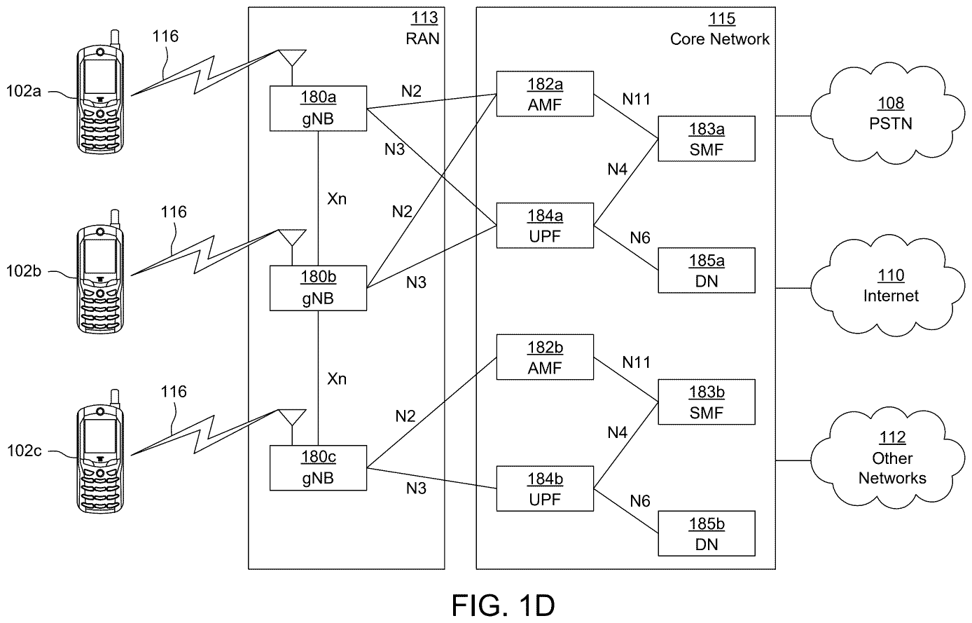

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA20001X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### [Near-Field Communication]

### [[The Near-Field Channel]]

With increasing transmission/reception point (TRP) antenna array aperture and carrier frequency, the classical planar wave approximation no longer holds in an increasing part of the coverage area, called the near field (NF). In contrast, the planar wave approximation is valid in what is called the far field (FF).

Legacy direction-based “far-field beamforming” suffers a loss in beamforming gain in the near field. However, in this case, a TRP sub-array could be used to generate a far field condition (in relation to the sub-array aperture).

For a user equipment (WTRU) in the near field, a first sub-array at one edge of the TRP array may correspond to a first WTRU receive/transmit (Rx/Tx) beam, while a second sub-array at the other edge of the TRP array may correspond to a second WTRU Rx/Tx beam that is different from the first. This is due to the larger angle that the TRP array spans from the perspective of the near-field WTRU, compared to a far-field WTRU.

It may be beneficial to use a subset of the TRP sub-arrays to serve a WTRU in the near field, e.g.: the WTRU signal-to-noise power ratio (SNR) is high due to small pathloss in the near field; the TRP may turn off remaining sub-arrays, thereby saving network energy; and multi-user multiple input multiple output (MU-MIMO) can be achieved, with the near-field WTRU served by a first subset of the TRP sub-arrays and a second WTRU (in the far or near field) can be served by a second subset of TRP sub-arrays.

### [[Spatial Degrees-of-Freedom in the Near Field Line-of-Sight (LOS) Channel]]

In the far field, a channel with a LOS path may have a single spatial Degree-of-Freedom (DoF), or two spatial DoF if dual-polarized transmission and reception is implemented. In the near field, however, a channel with a LOS path may have many DoF, due to the spherical wave propagation. The DoF of a WTRU's channel is indicative of the number of data transmission layers, also called single-user (SU) MIMO rank, that can be supported by the channel.

### [DL-Based UL MIMO in 5G NR]

### [[SRS Transmission]]

In NR, a WTRU may be configured with one or more sounding reference signal (SRS) resource sets. An SRS resource set may be configured with a usage called non-codebook.

The SRS resource set may be configured with an associated channel state information reference signal (CSI-RS), typically a multi-port CSI-RS. The WTRU estimates the DL channel based on the associated CSI-RS. The WTRU determines rank-1 precoders for the single-port SRS resources in the set based on the associated CSI-RS. Typically, the precoders are determined based on an estimated uplink (UL) channel that the WTRU determines from the downlink (DL) channel, assuming DL/UL channel reciprocity.

Alternatively, each of the SRS resources in the SRS resource set may be configured with a spatial relation or a transmission configuration indication (TCI) state. The spatial relation or TCI state may comprise a DL RS, e.g., a synchronization signal and physical broadcast channel (SS/PBCH) block (SSB) or a CSI-RS. The WTRU determines a DL Rx beam based on the DL RS. This may involve DL Rx beam sweeping during multiple transmission occasions of the DL RS. Based on DL/UL beam correspondence, the WTRU determines an UL Tx beam based on the DL Rx beam.

The WTRU transmits the SRS resources in the SRS resource set using the determined precoders or UL Tx beams.

The network receives the SRS resources and determines which one or more SRS resources to indicate for a subsequent PUSCH.

### [[Non-Codebook Based PUSCH Transmission Scheme]]

Physical uplink shared channel (PUSCH) transmission may be scheduled by downlink control information (DCI) that also indicates one or more SRS resources, through an SRS resource indicator (SRI) field. This transmission scheme is called non-codebook based.

The number of indicated SRS resources also indicate the number of PUSCH layers to transmit, also called the PUSCH rank.

When the WTRU transmits the PUSCH, it transmits the first PUSCH layer using the same beam or precoder the WTRU used to transmit a first indicated SRS resource. In case of two indicated SRS resources, the WTRU transmits the second PUSCH layer using the same beam or precoder the WTRU used to transmit a second indicated SRS resource, and so on for more than two layers.

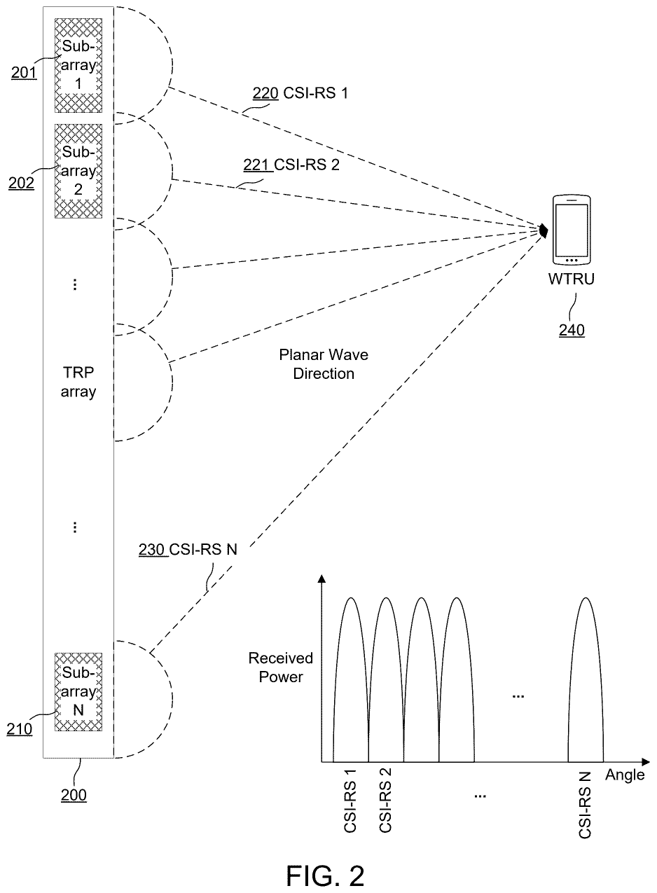

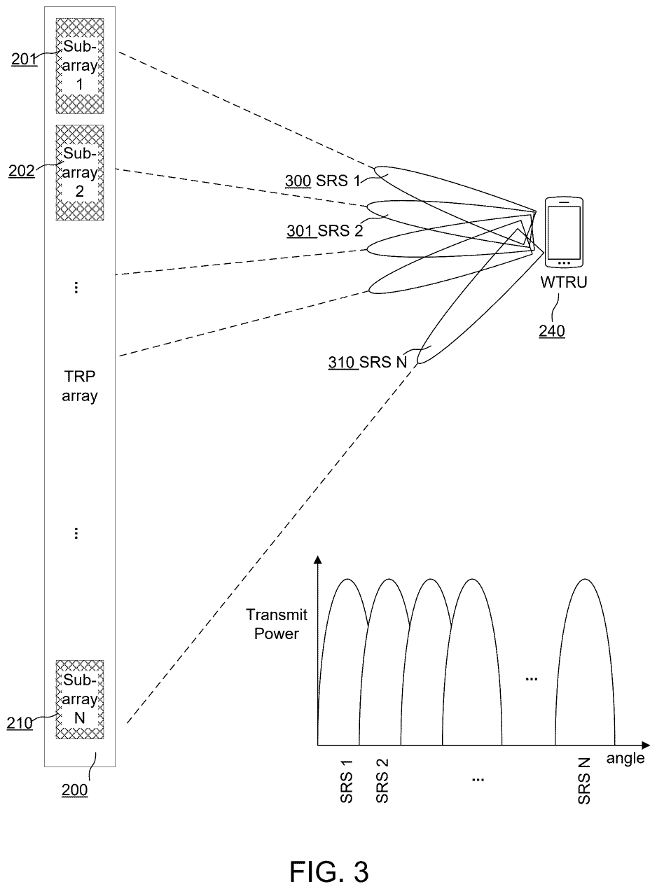

NF UL MIMO, using non-codebook based PUSCH, may be implemented for instance as follows, and as illustrated in FIG. 2 and FIG. 3:

In FIG. 2, a number N of CSI-RS (i.e., N CSI-RS) (220, 221, . . . , 230) are transmitted from antennas/sub-arrays (201, 202, . . . , 210) spanning a whole TRP (or gNB, or network node) array (200). According to a first transmission scheme (Scheme 1): N CSI-RS=N CSI-RS antenna ports; according to a second transmission scheme (Scheme 2): N CSI-RS=N single-port CSI-RS resources;

A WTRU (240) receives the N CSI-RS, e.g., from slightly different angles due to NF propagation. The angles corresponding to adjacent (in angle) CSI-RS have a separation. The set of N CSI-RS has an angular separation or spread as well. The bottom right of FIG. 2 illustrates a graph with each CSI-RS received at the WTRU on the x-axis as a function of the reception angle and against received power on the y-axis;

In FIG. 3, WTRU (240) transmits N single-port SRS resources (300, 301, . . . , 310) with UL Tx precoders/beams based on the N CSI-RS (220, 221, . . . , 230). The angles of the adjacent UL Tx precoders/beams are separated. Also, the whole set of SRS/beams has a separation or spread; and

N is large enough to facilitate near-field UL MIMO and UL MU-MIMO scheduling flexibility, e.g., N=8 or N=16.

Even though the WTRU (240) is in the near field of the whole TRP array (200), the WTRU may be in the FF of a TRP sub-array (e.g., one of subarrays 201, 202, . . . , 210), as indicated by the text ‘Planar Wave Direction’ in FIG. 2.

The bottom right of FIG. 3 illustrates a graph with each SRS transmitted by the WTRU (240) on the x-axis as a function of the transmit angle and against transmit power on the y-axis.

Note that the TRP/gNB/base station/network node may need to configure and transmit at least as many CSI-RS as the maximum PUSCH rank. A higher number of CSI-RS (and corresponding single-port SRS resources) than the maximum PUSCH rank would give the network a higher spatial scheduling flexibility for both MU-MIMO and SU-MIMO PUSCH.

The WTRU typically needs to receive each of these CSI-RS, for channel matrix estimation (e.g., for the previously mentioned Scheme 1) or Rx beam sweeping (e.g., for previously mentioned Scheme 2). The multiple (N) CSI-RS resources imply both a DL resource overhead and a corresponding WTRU Rx effort.

It would therefore be interesting to reduce the CSI-RS resource overhead and the corresponding WTRU Rx effort for near-field UL MIMO, without sacrificing the network spatial scheduling flexibility.

### Overview

### [NF UL MIMO Operation]

An important concept herein is the beam separation of a beam set, as described previously. The transmission of a beam set with a suitable beam separation in a near field scenario, e.g., line-of-sight in the near field, may unlock the degrees-of-freedom in the near field channel, wherein the channel may comprise the effective channels corresponding to the beam set. The network may choose multiple beams from the beam set for single-user MIMO, or one or more beams from the beam set for multi-user MIMO.

Note that various embodiments herein may also be applicable for a WTRU in the far field. The transmission of multiple SRS with a beam separation, based on a single spatial reference, may give the network more freedom to choose UL Tx beam, compared to the case with single UL Tx beam based on a DL RS, e.g., if the DL/UL beam correspondence in inaccurate or if the WTRU moves/rotates rapidly.

Various embodiments herein may be motivated based on the observation/assumption that the antennas in a TRP array are, more or less, uniformly distributed around the center (or middle) of the array, e.g., around the center sub-array in a planar array. Note, however, that the embodiments herein are compatible also with other assumptions on TRP array architecture, etc. For NF UL MIMO, it may be sufficient if the WTRU keeps track of the direction to the array center and then transmits SRS resources with a suitable SRS Tx beam separation around the direction to the center.

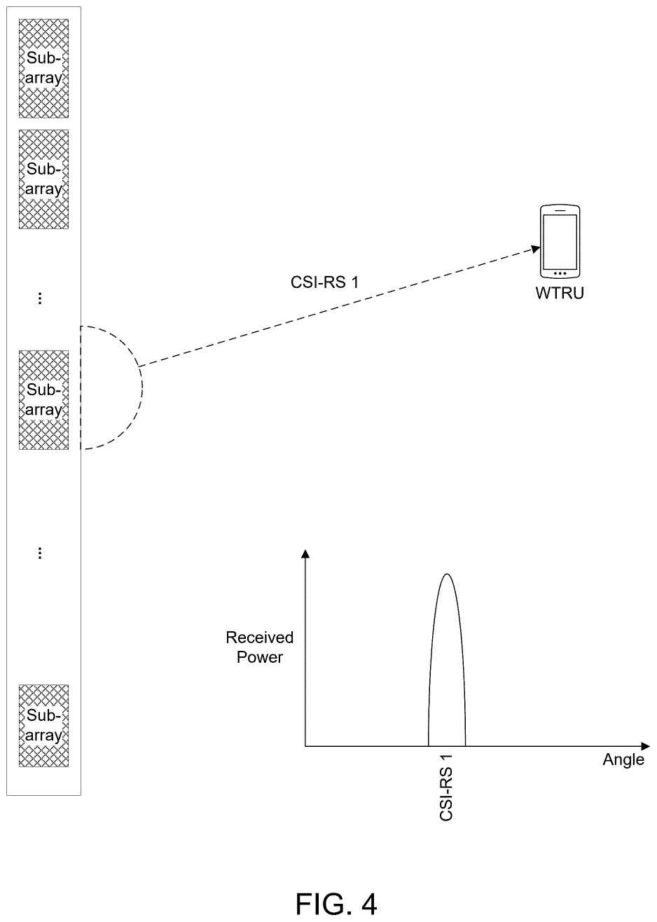

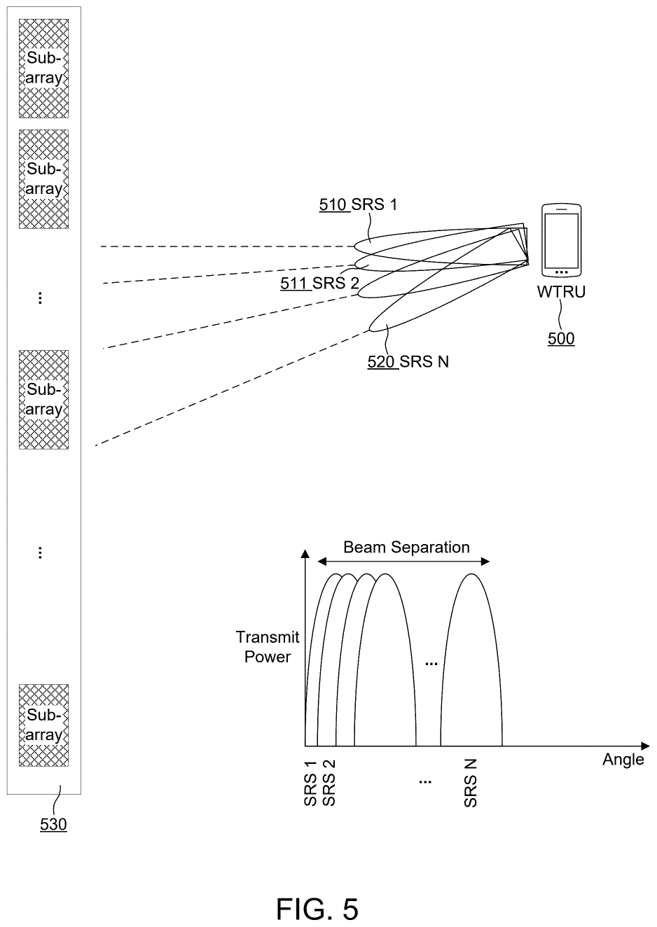

A single CSI-RS may be sufficient for maintaining the direction (e.g., reference direction) towards the array center, see FIG. 4. Upon SRS transmission, the network can estimate if the SRS resources span a too small or too large SRS Tx beam separation (angle) and indicate to the WTRU to increase/decrease the SRS Tx beam separation of the SRS resources. FIG. 5 illustrates a WTRU (500) transmitting N SRS resources (510, 511, . . . , 520) in direction of an antenna array (530) of a TRP, with too small SRS Tx beam separation. Note that the network (e.g., the TRP, the gNB, the network node) might not be aware of the actual, e.g., absolute, beam separation at the WTRU side. The measured beam separation at the network side may depend on both the beam separation (in terms of angle) at the WTRU side as well as the distance between the WTRU and the TRP array.

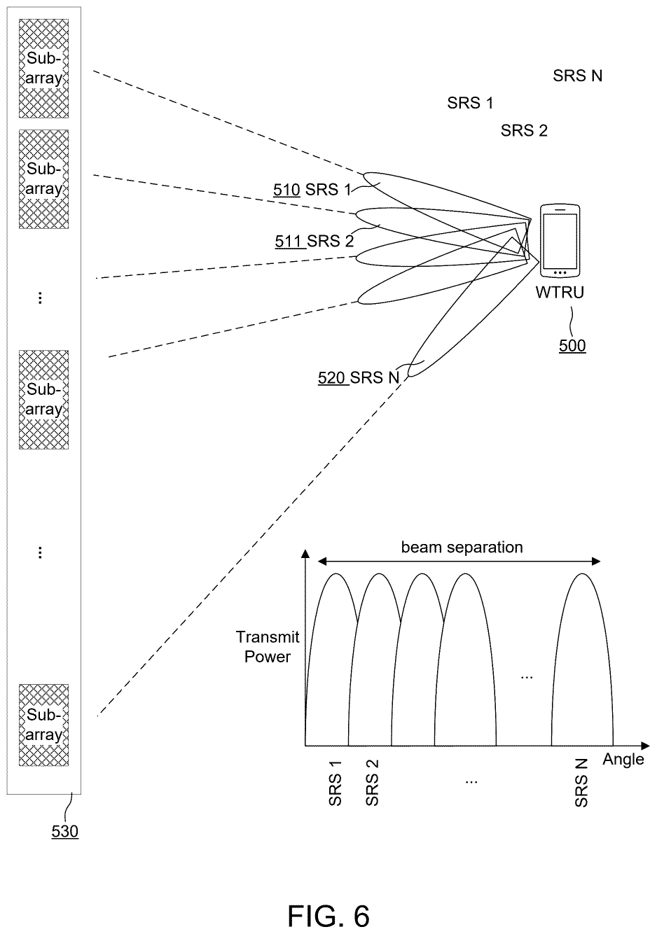

As a further enhancement, if the network requests the WTRU to increase the SRS Tx beam separation below the WTRU capability, the WTRU may omit the transmission of some SRS resources. If the network requests the WTRU to increase the beam separation, the WTRU may start to transmit some previously omitted SRS resources. See for example FIG. 6, where a WTRU (500) transmits SRS resources (510, 511, . . . , 520) with proper SRS Tx beam separation (e.g., the SRS Tx beam separation at the WTRU is now such that the SRS Tx beams are correctly spread over the array, e.g., such that the aggregate channel combining each individual SRS has a higher rank), e.g., after reception of a beam separation increase or decrease indication from the network and following increase or decrease by the WTRU. Note that it is typically not required that the individual SRS beams match the individual sub-arrays.

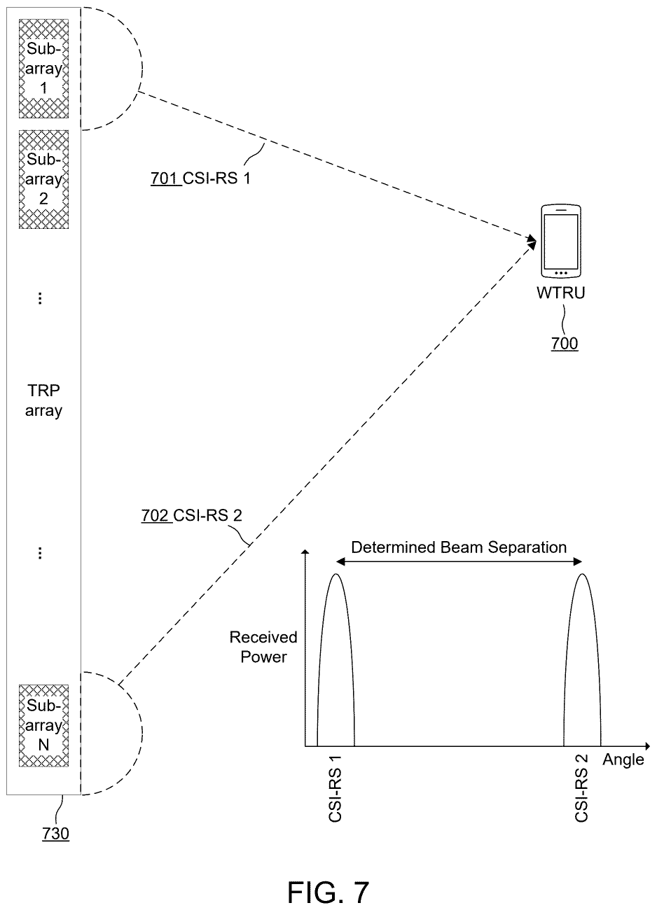

In another embodiment, also considered herein, the WTRU may determine a beam separation based on one or more received CSI-RS, e.g., two for a linear or a rectangular planar array or four for a planar array. The CSI-RS may be transmitted from the edges or corners of the TRP array, e.g., antennas and/or sub-arrays at the outer edges/corners of the array. The received CSI-RS may be used by the WTRU to determine a beam separation. FIG. 7 illustrates a scenario with two CSI-RS (CSI-RS 1 (701) and CSI-RS 2 (702)) that the WTRU (700) may receive from TRP (730) and utilize to determine a beam separation for a subsequent UL transmission, e.g., SRS.

Upon WTRU transmission of a set of SRS using a corresponding set of UL Tx beam with a suitable beam separation, and corresponding reception of the set of SRS by the network, the network may subsequently select one or more of the UL Tx beam(s), e.g., by indicating the corresponding SRS in the transmitted set of SRS, for an UL transmission, e.g., PUSCH. With the proper beam separation, a PUSCH with as high rank as possible may be scheduled by the network, which may result in significantly increased UL performance (e.g., throughput, data rate) for the WTRU. Furthermore, in a scenario with multiple UEs that can be co-scheduled on the same time-frequency resources, the network may select one or more of the UL Tx beams for a subsequent PUSCH such that the UL Tx beams result in minimal inter-WTRU interference in the network-side multi-user receiver. Efficient MU-MIMO may significantly increase both WTRU performance and network capacity.

### [WTRU Reports its Capability]

The WTRU may report its capability, e.g., in an RRC message, which may be carried in a PUSCH transmitted by the WTRU. The network may receive the capability reported by the WTRU.

### [[Beam Separation WTRU Capability]]

The WTRU may report its capability regarding beam separation, beam separation indication, etc.

The WTRU may report if it supports indication of beam separation, e.g., for a set of SRS.

The WTRU may report the number of beam separation levels it supports. The WTRU may report separate number of supported beam separation levels for different corresponding sets of SRS, e.g., different set sizes. For example, a WTRU may report a first number of supported beam separation levels for a first number of SRS in a corresponding set of SRS, e.g., two SRS, and a second number of supported beam separation levels for a second number of SRS in a corresponding set of SRS, e.g., three SRS, etc.

The WTRU may report the maximum beam separation level it supports, which may be equivalent to the number of supported beam separation levels, e.g., if the lowest level is fixed or pre-configured such as beam separation level 0. The lowest level may correspond to no beam separation, e.g., the SRS may be transmitted with the same beam.

The WTRU may report its capability regarding simultaneous transmission of SRS, e.g., the number of SRS that it is capable of transmitting simultaneously with different SRS Tx beams.

### [WTRU Receives Configuration]

The network may transmit and/or a WTRU may receive one or more configuration(s) and/or reconfiguration(s), e.g., with radio resource control (RRC) signaling, in one or more RRC message(s).

### [[WTRU Configuration of CSI-RS]]

### [[[Configured Set of CSI-RS]]]

The WTRU may receive a configuration of a configured set of one or more CSI-RS.

### [[[Single- or Multi-Port CSI-RS Resources]]]

The configured set of CSI-RS may correspond to a set of single-port CSI-RS resource(s), a set of dual-port CSI-RS resource(s), or a set of multi-port CSI-RS resource(s), e.g., a multi-port CSI-RS resource. The configured set of CSI-RS may correspond to CSI-RS resource(s) in one or more CSI-RS resource sets, e.g., non-zero-power CSI-RS resource sets.

The configured set of CSI-RS may correspond to a set of antenna ports, e.g., of one or more CSI-RS resource(s).

### [[[CSI-RS Time-Domain Behavior]]]

The CSI-RS may be configured to be periodic, e.g., the WTRU may receive the CSI-RS with a configured periodicity and time offset to a time reference.

A time reference may for instance be a slot or frame timing of a serving cell, e.g., the serving cell in which the CSI-RS are configured or received.

The CSI-RS may be configured to be semi-persistent. When the CSI-RS is activated, the WTRU may receive the CSI-RS with a configured periodicity and time offset to a time reference. The WTRU may receive a CSI-RS activation and/or deactivation indication for a semi-persistent CSI-RS in a medium access control (MAC) control element (CE) or in a downlink control information (DCI). A MAC CE may be carried in a PDSCH. A DCI may be carried in a PDCCH.

The CSI-RS may be configured to be aperiodic, e.g., the WTRU may receive one or more occasions of an aperiodic CSI-RS after the reception of a DCI that triggers the CSI-RS. The WTRU may receive the CSI-RS a time offset after receiving the PDCCH that carried the DCI that triggered the CSI-RS, for example a configured time offset, or a time offset indicated by the DCI, or a combination thereof.

### [[[CSI-RS With/Without Repetition]]]

A CSI-RS may be configured or indicated with or without repetition enabled.

For a CSI-RS with repetition enabled, the WTRU may receive multiple occasions of the CSI-RS, e.g., in consecutive symbols or slots. The WTRU may assume that the multiple occasions were transmitted on the same effective channel, e.g., with the same Tx beam. The WTRU may use the multiple occasions for adjusting its Rx beam.

For a CSI-RS with repetition disabled, the WTRU may receive multiple occasions of the CSI-RS, e.g., separated by the CSI-RS periodicity. The WTRU may use the multiple occasions for adjusting its Rx beam, even though the WTRU might not assume that the occasions were transmitted on the same effective channel, e.g., with the same Tx beam.

### [[WTRU Configuration of SRS]]

### [[[Configured Set of SRS]]]

The WTRU may receive a configuration of one or more configured set(s) of one or more SRS.

### [[[SRS Resources and SRS Resource Set(s)]]]

A configured set of SRS may for example correspond to a set of single-port SRS resource(s), a set of dual-port SRS resource(s), or a set of multi-port SRS resource(s). A configured set of SRS may correspond to SRS resource(s) in one or more SRS resource sets. A configured set of SRS may correspond to an SRS resource set.

One or more SRS may be associated with an SRS Id. For example, an SRS resource may be configured with an SRS resource Id. In another example, an SRS resource set may be configured with an SRS resource set Id.

A configured set of SRS may correspond to a set of antenna ports, e.g., of one or more SRS resource(s).

Note that different sets of SRS may be configured with different spatial references, e.g., one or more CSI-RS.

### [[[SRS Time-Domain Behavior]]]

The SRS may be configured to be periodic, e.g., the WTRU may transmit the SRS with a configured periodicity and time offset to a time reference.

A time reference may for instance be a slot or frame timing of a serving cell, e.g., the serving cell in which the SRS are configured or received. The time reference may also include a timing advance configured and/or indicated to the WTRU.

The SRS may be configured to be semi-persistent. When the SRS is activated, the WTRU may transmit the SRS with a configured periodicity and time offset to a time reference. The WTRU may receive an SRS activation and/or deactivation indication for a semi-persistent SRS in a medium access control (MAC) control element (CE) or in a downlink control information (DCI). A MAC CE may be carried in a PDSCH. A DCI may be carried in a PDCCH.

The SRS may be configured to be aperiodic, e.g., the WTRU may transmit one or more occasions of an aperiodic SRS after the reception of a DCI that triggers the SRS. The WTRU may transmit the SRS a time offset after receiving the PDCCH that carried the DCI that triggered the SRS, for example a configured time offset, or a time offset indicated by the DCI, or a combination thereof.

### [[[Set(s) of SRS Associated With Beam Separation Indication]]]

The WTRU may receive a configuration that associates one or more sets of SRS with a beam separation indication. The beam separation indication may be applicable to the associated set(s) of SRS.

Beam separation indications may be configured to correspond to different beam separation Ids, or beam separation indication Ids. A set of SRS may be configured to be associated with beam separation indication with one or more Ids.

[[WTRU Configuration of Spatial Relations and/or TCI States]]

The WTRU may receive a configuration of a set of one or more spatial relations and/or one or more TCI states.

### [[[Spatial Reference Configuration]]]

A spatial relation and/or TCI state may comprise an RS that the WTRU may use as a spatial reference for an UL transmission. A spatial reference may comprise a spatial relation and/or a TCI state, such as a joint DL/UL TCI state or an UL TCI state. Using a DL RS as a spatial reference for an UL signal/channel may mean that the WTRU uses the (DL Rx) beam used to receive the DL RS as the (UL Tx) beam to transmit the UL signal/channel, e.g., based on beam correspondence as described above. Similarly, using an UL RS as a spatial reference for an UL signal/channel may mean that the WTRU uses the (UL Tx) beam used to transmit the UL RS as the (UL Tx) beam to transmit the UL signal/channel.

A TCI state, e.g., a joint DL/UL TCI state or a DL TCI state, may comprise one or more source RS(s) that the WTRU may use as quasi-co-location (QCL) source RS(s) for receiving a DL signal/channel. The TCI state may also comprise a configuration of one or more QCL types applicable to the one or more source RS(s), wherein the QCL type may comprise one or more of Doppler shift, Doppler spread, average delay, delay spread, and spatial Rx parameter.

A set of one or more SRS may be configured with one or more spatial reference(s). In an example, an SRS resource in an SRS resource set may be configured with one or more spatial reference(s), e.g., through one or more spatial relations or TCI states.

A set of SRS may be configured with an associated CSI-RS as spatial reference.

### [[WTRU Receives CSI-RS]]

The network may transmit and/or the WTRU may receive one or more CSI-RS from the set of configured CSI-RS, e.g., all CSI-RS in the set of configured CSI-RS. The received CSI-RS may correspond to one or more spatial references.

The WTRU may receive one or more occasions of one or more configured periodic CSI-RS. The WTRU may receive one or more occasions of one or more configured and activated semi-persistent CSI-RS. The WTRU may receive one or more occasions of a configured and triggered aperiodic CSI-RS. If configured, a CSI-RS occasion may comprise CSI-RS repetition.

The WTRU may use one or more DL Rx beam(s) for receiving the one or more CSI-RS occasions, whereby the WTRU may determine a DL Rx beam for the CSI-RS.

The WTRU may estimate a DL channel based on the received CSI-RS.

The WTRU may determine one or more direction(s) based on the one or more received CSI-RS. For instance, the WTRU may determine N direction(s), e.g., beam directions, corresponding to N received CSI-RS. In various examples herein, N=1, N=2, and N=4.

The direction(s) determined, by the WTRU, from the one or more received CSI-RS may be denoted reference direction(s).

For example, for N=1, the reference direction may be determined directly based on the CSI-RS, e.g., based on the beam direction of the WTRU Rx beam used to receive the CSI-RS, an estimated angle-of-arrival of the CSI-RS, or similar.

For example, for N=2, one or more reference direction(s) may be determined directly based on the CSI-RS, as for N=1. For instance, a reference direction is determined based on one of the CSI-RS, or two reference directions are determined based on both CSI-RS, e.g., a direction per CSI-RS. In another example, a reference direction is determined based on the two directions directly determined from the CSI-RS. For instance, the reference direction is determined as an average direction between the two directions.

For N=4, reference direction(s) may be determined as for N=2, e.g., with a reference direction per received CSI-RS. For the single reference direction case, it may be determined as the average of the four directions determined from the four CSI-RS.

### [[WTRU Receives Indication to Transmit SRS]]

### [[[SRS Transmission Subset]]]

The term SRS transmission subset may correspond to an SRS subset that the WTRU is to transmit. An SRS transmission subset may be a configured set of SRS or a subset of a configured set of SRS. An SRS transmission subset may be configured to the WTRU, indicated to the WTRU, e.g., via an indicator carried in a DCI, MAC CE, or similar, and/or determined by the WTRU, or a combination thereof.

In an example, the WTRU is configured with multiple separate sets of SRS, e.g., SRS resource sets, that may have different sizes. The sets of SRS may correspond to SRS subsets. An SRS transmission subset may correspond to a set of SRS from the multiple sets of SRS.

### [[[Indication to Transmit SRS]]]

The network may transmit and/or the WTRU may receive an indication to transmit SRS. For example, the indication may comprise a trigger to transmit an SRS transmission subset, e.g., one or more aperiodic SRS. In another example, the indication may comprise an indication to activate the transmission of an SRS transmission subset, e.g., one or more semi-persistent SRS.

### [[[Indication of an SRS Transmission Subset]]]

The network may transmit and/or the WTRU may receive an indication of an SRS transmission subset of a configured set of SRS. Such an indication may be received together with, or separately from, an indication to transmit the SRS transmission subset. The indication of the SRS transmission subset may comprise an indication to transmit the SRS transmission subset.

It may be beneficial to enable the indication, and thereby adaptation of, the SRS transmission subset, e.g., for a beam separation. For example, the network may determine that it is not worthwhile for the WTRU to transmit more SRS (than the indicated), since they cannot be sufficiently resolved at the network side. Hence, a smaller number of transmitted SRS may provide a suitable trade-off between the WTRU's SRS transmission effort and network-side scheduling flexibility. Furthermore, the network may be aware of, and take into account, the WTRU capabilities, e.g., in terms of beam separation, such that the SRS transmission subset is not larger than the number of different UL Tx beams the WTRU can generate for a beam separation.

In an example with a configured set of periodic SRS, the indication to transmit an SRS transmission subset of the periodic SRS may indicate to the WTRU to transmit only the subset of the configured set of periodic SRS.

Note that the SRS transmission subset may be both indicated to the WTRU and subsequently determined by the WTRU, e.g., based on the indicated SRS transmission subset. In other words, the WTRU may be indicated an indicated SRS transmission subset, and the WTRU may determine a determined SRS transmission subset. The WTRU may determine the determined SRS transmission subset based on the indicated SRS transmission subset. In some cases, with both an indicated SRS transmission subset and a determined SRS transmission subset, the WTRU may transmit the first. In other cases, the WTRU may transmit the latter.

### [[[Indication of the SRS Transmission Subset Size and Subsequent WTRU Determination of SRS Transmission Subset]]]

The indication of an SRS transmission subset may comprise a number corresponding to the size of the subset, or the number of SRS in the subset. Based on the indicated number, the WTRU may determine the subset from the configured set of SRS, e.g., determine which SRS to include in the subset. For example, the WTRU may include the SRS corresponding to lowest (or highest) Ids in the subset, for example SRS resource Id, SRS antenna port Id, etc. Alternatively, the WTRU may determine which SRS to include in the subset based on properties of the SRS, e.g., SRS resources, for instance time domain, frequency domain properties, etc.

In an example, the WTRU includes in the subset SRS based on the timing relationship between the reception of the indication and the corresponding SRS. The WTRU may include in the subset the SRS the SRS(s) with closest transmission timing after a time instance, where the time instance may comprise the reception time of an indication, e.g., the SRS transmission indication and/or the SRS subset indication, plus a threshold that may be configured to the WTRU, depend on the WTRU capability, etc.

In an example, the WTRU includes in the subset SRS based on the frequency domain span of the SRS. For instance, the WTRU first includes SRS that span the same, or almost the same, bandwidth, e.g., the same resource blocks (RBs), bandwidth part (BWP), serving cell, carrier, etc.

SRS, e.g., SRS antenna ports, may be transmitted in the same SRS comb, where an SRS comb may correspond to a set of time-frequency resources, e.g., resource elements (REs) used for SRS transmission. For example, a comb may correspond to a slot and symbol offset, a frequency domain density, a sub-carrier offset, etc. The WTRU may transmit different SRS on the same SRS comb by applying different parameters to the different SRS, e.g., different cyclic shifts, base sequences, etc. In an example, the WTRU includes in the subset SRS based on the corresponding SRS combs. The WTRU may first include in the subset SRS that correspond to the same comb before including SRS that belongs to a different SRS comb that is not yet represented in the SRS subset.

### [[[Explicit Indication of the SRS Transmission Subset]]]

The indication of an SRS transmission subset may explicitly indicate the SRS(s) that are included in the subset. In an example, the indication may include one or more SRS Id, which are to be included in the subset. In a variation, the indication may include one or more SRS Id, which are to be excluded from the subset. In another example, the indication may comprise a bitmap, where a bit corresponds to an SRS. A particular bit value, e.g., ‘1’, corresponds to inclusion in the subset, while the other value corresponds to exclusion.

In another example, the indication comprises an indication of a set of SRS from multiple configured sets of SRS, e.g., a set Id such as an SRS resource set Id or an Id among SRS resource sets configured for a particular usage such as non-codebook, wherein the indicated set of SRS may correspond to the indicated SRS transmission subset. The multiple configured sets of SRS may have different sizes. In other words, the indication of a set of SRS from multiple configured sets of SRS may also indicate an SRS transmission subset size.

### [[[Default SRS Transmission Subset]]]

In some cases, the WTRU uses a default SRS transmission subset as the SRS transmission subset. The default SRS transmission subset may be applicable, e.g., if an SRS transmission subset has not yet been indicated. The default SRS transmission subset may be applicable if the WTRU has not yet been indicated a corresponding beam separation, or if the WTRU has been indicated the lowest beam separation. In another example, the default SRS transmission subset may be applicable as a fall back, for instance when a failure has been detected by the WTRU, such as a beam failure, link failure, etc. In yet another example, the WTRU may receive an indication to fall back to the default SRS transmission subset. The default SRS transmission subset may be applicable in one or more regions, such as an FF region, wherein in the region may be detected or determined by the WTRU or indicated to the WTRU.

The default SRS transmission subset may be configured to the WTRU or pre-configured. The default SRS transmission subset may comprise one or more SRS that may be determined by the WTRU using similar principles as for determining an SRS transmission subset based on an SRS subset size. In an example, the default SRS transmission subset comprises the single SRS with lowest Id, etc. In another example, the default SRS transmission subset comprises the SRS in a configured set of SRS, e.g., one or more configured SRS resource sets.

### [[WTRU Receives Indication of Beam Separation]]

### [[[General Description]]]

The network may transmit and/or the WTRU may receive an indication of beam separation, e.g., of a beam separation level. A beam separation indication may for example be carried in a DCI, MAC CE, or RRC message.

Indication of beam separation level is used as an example of indication of beam separation herein. However, the embodiments are equally applicable to other examples of beam separation indication, such as an indication of beam separation angle(s), direction(s), beam cross-correlation, beam set rank, beam set condition number, etc.

### [[[Association Between Beam Separation Indication and SRS]]]

A beam separation indication received by the WTRU may be associated with one or more set(s) of SRS, e.g., a configured set of SRS, wherein the association may be configured or indicated to the WTRU.

In one embodiment, the beam separation indication also indicates the associated set(s) of SRS. For example, an associated set of SRS is explicitly indicated, e.g., through an Id corresponding to the set of SRS, such as an SRS resource set Id, an Id among SRS resource sets configured for a usage, or similar.

In another example, the associated set(s) of SRS is implicitly indicated by the beam separation indication, e.g., a beam separation indication Id. This may be achieved by a configuration received by the WTRU in advance that may associate different values, e.g., corresponding to code points, of a beam separation indicator with set(s) of SRS.

In another embodiment, the associated set(s) of SRS may be indicated by another field than the beam separation indication.

For example, if the beam separation is indicated by a DCI, the beam separation indication field may be separate from an SRS request field that triggers transmission of the associated set(s) of SRS, such as one or more SRS transmission subset, e.g., when the SRS are aperiodic. In other words, the beam separation indication is associated with the indicated set(s) of SRS since they are indicated to the WTRU in the same information, e.g., in the same DCI.

In another example, if the beam separation is indicated by a MAC CE, the same MAC CE may indicate both a beam separation and one or more set(s) of SRS, such as one or more SRS transmission subsets, e.g., when the SRS are periodic and/or semi-persistent. The MAC CE carrying a beam separation indication may also function as an activation/deactivation of the set(s) of SRS, e.g., when the SRS are semi-persistent.

In some cases, the WTRU receives a configuration that indicates one or more sets of SRS that are associated with a beam separation indication. The WTRU may determine the associated set(s) of SRS based on in which BWP, cell, carrier, band, frequency range, etc., that the WTRU received the beam separation indication. For instance, the WTRU may determine as associated the set(s) of SRS that are configured in the BWP, cell, carrier, band, frequency range, etc.

### [[[Applicability of the Indicated Beam Separation]]]

An indicated beam separation level may be applicable to one or more transmission occasions of an associated set of SRS. For instance, the indicated level may be applicable to a single transmission occasion of an associated set of SRS, e.g., in the case of aperiodic SRS. In another example, the indicated level may be applicable to one or more transmission occasion of an associated set of SRS, e.g., until a different level (e.g., associated with the same set of SRS) has been indicated to the WTRU, e.g., in the case of semi-persistent or periodic SRS. The indicated beam separation level may be applicable for an associated set of SRS until the associated set of SRS has been deactivated, e.g., for semi-persistent SRS.

An indicated beam separation level may be applicable to an angular dimension. For example, the WTRU may receive two indications of beam separation, with a first indication applicable to a first angular dimension and a second indication applicable to a second angular dimension. The beam separation indication may also comprise an indication, e.g., a binary indicator, of which angular dimension the indication is applicable to.

### [[[Indication of Absolute Beam Separation Level]]]

The network may transmit and/or the WTRU may receive an indication of a beam separation level, e.g., an absolute beam separation level. The indication may comprise an integer value corresponding to the indicated level. The WTRU may determine the beam separation level as the indicated (absolute) beam separation level, e.g., regardless of the previously received beam separation indications, e.g., for the associated set(s) of SRS.

### [[[Indication of Beam Separation Level Adjustment]]]

The network may transmit and/or the WTRU may receive an indication of a beam separation level adjustment, e.g., an increased beam separation level, decreased beam separation level, or unchanged beam separation level.

The WTRU may determine a beam separation level based on the indicated beam separation level adjustment, and a previous beam separation, e.g., beam separation level. For instance, the WTRU increases or decreases the beam separation level, based on the indication, in relation to the previous beam separation level, e.g., for the associated set(s) of SRS. The previous beam separation or beam separation level, in turn, may be a default beam separation or beam separation level, a beam separation level that was adjusted based on a previously received indication of beam separation change, or a beam separation level determined based on an indication of absolute beam separation level, a beam separation determined from multiple received CSI-RS, etc.

The initial beam separation level may for example correspond to no beam separation or the lowest supported beam separation.

The indication of level adjustment may comprise multiple step sizes. For example, the WTRU may receive an indication to increase the beam separation level by 1 (step), by 2 (steps), etc., or decrease the beam separation level by 1 (step), 2 (steps), etc.

### [[[Indication of Both Absolute Beam Separation Level and Beam Separation Level Adjustment]]]

The network may transmit and/or the WTRU may receive an indication of beam separation that includes either an indication of an absolute beam separation level or an indication of level adjustment. For instance, level adjustment (increase/decrease/unchanged) or an absolute level may be indicated. For instance, an indication to return to a default beam separation may be indicated.

[[[Indication of Multiple Beam Separation Levels and/or Level Adjustment]]]

The network may transmit and/or the WTRU may receive multiple indications of beam separation, where the different indications may apply to different beam sets corresponding to different sets of SRS. One or more indications of the received indications may correspond to beam separation between different beam sets. In other words, the beams may be grouped in multiple beam sets, and a first set of beam separation indications may to beam separation within a beam set and a second set of beam separation indications may apply to beam separation between beam sets. The beam separation between beam sets may for instance correspond to the separation between centers, reference, or main directions of beam sets. For simplicity of presentation, the beam separation for a beam set is used as an example to describe the embodiments herein, but the embodiments may be equally applicable to separation between beam sets.

### [[WTRU Determines Beam Separation]]

### [[[General Description]]]

The WTRU may determine a beam separation, for instance for one or more set(s) of SRS, such as for a configured set of SRS or an SRS transmission subset. The determination may be based on one or more of: one or more WTRU capabilities, e.g., reported capabilities; a default beam separation; the number of SRS, e.g., in the SRS transmission subset; one or more received CSI-RS; and/or one or more received indication(s) of beam separation.

### [[[[Further Elaboration on Relation Between Overall Beam Separation and Number of SRS]]]]

For the case that beam separation, e.g., beam separation indication, corresponds to beam separation of the whole beam set, e.g., overall beam separation, a beam separation can be maintained also if the size of the beam set changes, e.g., if the number of SRS in the SRS transmission subset changes. With a changing number of beams, e.g., increasing number of beams, the separation between adjacent beams may change, e.g., decrease, while the overall beam separation is maintained. In other words, for different numbers of SRS and corresponding beams, the WTRU may adjust the separation between adjacent beams, in order to meet the overall beam separation.

In an example, in 2D for simplicity, the WTRU first transmits 8 SRS/beams with 4-degree separation between adjacent beams to cover a 28-degree range (e.g., beams directions at −14, −10, −6, −2, 2, 6, 10, 14 degrees). If the WTRU receives an indication to increase the beam separation for the same number of SRS/beams, the WTRU may increase the separation of adjacent beams to 6 degrees, such that the overall beam separation would increase to 42 degrees (e.g., −22, −16, −10, −4, 2, 8, 14, 20 degrees). If on the other hand, the WTRU receives an indication to only transmit 4 SRS/beams, with the same beam separation, the WTRU may increase the separation of adjacent beams to 9-10 degrees, such that the overall beam separation would remain 28 degrees (e.g., beam directions at −14, −5, 4, 14).

### [[[[Further Elaboration on Relation Between Beam Pair Separation and Number of SRS]]]]

For the case that beam separation, e.g., beam separation indication, corresponds to beam separation between one or more pairs of beams, e.g., adjacent beam pairs, overall beam separation may change if the size of the beam set changes, e.g., if the number of SRS in the SRS transmission subset changes. For instance, with maintained beam separation between adjacent beams, an increased number of beams/SRS may increase the overall beam separation (of the whole set). Furthermore, consider the case that the WTRU receives an indication to increase (beam pair) beam separation and an indication to reduce the number of SRS. These two indications may have contrary effects on the overall beam separation as an increased (beam pair) beam separation, on its own, would increase overall beam separation, while a reduced number of SRS, on its own, would decrease the overall beam separation. In this case, the aggregated effect may be up to WTRU implementation. Alternatively, the effect may be defined in a specification by equating an increase/decrease in (beam pair or inter-beam) beam separation, e.g., by a particular number of steps/levels, to an increase/decrease in the number of beams/SRS, e.g., by a particular fraction. For example, a beam separation level increase of one step may correspond to, e.g., be equal to, an increase of the number of beams/SRS by X %.

In an example, in two dimensions (2D) for simplicity, the WTRU first transmits 4 SRS/beams with 10-degree separation between adjacent beams to cover a 30-degree range (e.g., beams directions at −20, −10, 0, 10 degrees). If the WTRU receives an indication to transmit an increased number of SRS/beams, e.g., 6 SRS/beams, the overall beam separation may increase to 50 degrees (e.g., −30, −20, −10, 0, 10, 20 degrees). If on the other hand, the WTRU receives an indication to only transmit 3 SRS/beams, with an increased same beam separation between adjacent beams, the overall beam separation may increase, decrease, or remain unchanged. In a first example, the WTRU changes directions −20, −5, 10, which means that the overall beam separation remains unchanged. In a second example, the WTRU changes directions to −18, −5, 8, which means that the overall beam separation is decreased.

### [[[Determination Based on Indicated Beam Separation]]]

The network may transmit and/or the WTRU may receive one or more indications of beam separation, e.g., of beam separation level. The WTRU may determine beam separation based on the one or more received indications.

In general, a plurality of beam separation levels may be ordered in order of beam separation. The WTRU may determine the correspondence between indicated beam separation level and beam separation according to one or more of the following: a lower indicated beam separation level corresponds to smaller beam separation; a lower indicated beam separation level corresponds to smaller or equal beam separation; a higher indicated beam separation level corresponds to larger beam separation; a higher indicated beam separation level corresponds to larger or equal beam separation; the lowest indicated beam separation level corresponds to a smaller beam separation than the beam separation corresponding to the highest indicated beam separation level; an unchanged indicated beam separation level corresponds to equal beam separation.

In some cases, each beam separation level corresponds to a different beam separation. In some cases, some beam separation levels, e.g., two or more adjacent levels, correspond to equal beam separation.

Note that equal beam separation may correspond to equal, or similar beam separation, e.g., equal beam separation within separation margin, which may be pre-configured, configured, or based on a WTRU capability.

The lowest beam separation level may for instance correspond to one or a combination of the following: no beam separation, e.g., a single UL Tx beam may be used; the smallest beam separation that the WTRU is capable of, e.g., given a certain number of beams; a default beam separation, e.g., the lowest beam separation level.

In a typical embodiment, the lowest indicated beam separation level corresponds to a smaller beam separation than the beam separation corresponding to the highest indicated beam separation level.

### [[[Determination Based on Received CSI-RS]]]

The network may transmit and/or the WTRU may receive one or more CSI-RS, e.g., as described above. The WTRU may determine a beam separation based on the one or more received CSI-RS. The WTRU may be configured or indicated that it may use the one or more CSI-RS to determine a beam separation.

In an example, the one or more CSI-RS may be configured as spatial reference(s), e.g., in one or more TCI state(s), or similar, that are applicable to the associated SRS, e.g., a configured set of SRS from which the WTRU determines an SRS transmission subset.

In other words, the WTRU may be configured with quasi-colocation (QCL) information, e.g., in one or more TCI state(s), that the WTRU may determine one or more spatial parameters from the one or more CSI-RS, e.g., beam separation, angular spread, beam direction(s), etc. The spatial parameters may correspond to a QCL type, e.g., an enhanced legacy QCL type D or a new QCL type.

In another example, the CSI-RS may be configured as associated with the configured set of SRS. In yet another example, the CSI-RS may be indicated, e.g., in a DCI or MAC CE that trigger or activates the associated SRS.

### [[[[Determination Based on a CSI-RS]]]]

The WTRU may determine a beam separation based on a received CSI-RS.

This embodiment may be beneficial for example if the CSI-RS is transmitted from the full TRP array. Thereby, the WTRU may receive CSI-RS energy from a range of angles/directions, e.g., corresponding to the angles/directions that the TRP array spans in line-of-sight, from the perspective of the WTRU. The WTRU may determine a beam separation based on the range of angles/directions.

[[[[Determination Based on Two CSI-RS]]]]

The WTRU may determine a beam separation based on two received CSI-RS.

The WTRU may determine two directions, e.g., beam directions, based on the two CSI-RS. Based on the two directions, the WTRU may determine a beam separation, e.g., by determining a maximum angle or angular range according to the two directions.

This approach may be beneficial for example if the two CSI-RS are transmitted from two edges of the TRP array, e.g., from two edge sub-arrays of a linear or planar array. Thereby, the WTRU may determine a proper beam separation based on the two CSI-RS.

### [[[[Determination Based on Four CSI-RS]]]]

The WTRU may determine a beam separation based on four received CSI-RS.

The WTRU may determine four directions, e.g., beam directions, based on the four CSI-RS. Based on the four directions, the WTRU may determine a beam separation, e.g., by determining a first beam separation in a first angular dimension and a second beam separation in a second angular dimension and determining a beam separation based on the first and second beam separations, e.g., as described above.

This approach may be beneficial for example if the four CSI-RS are transmitted from four corners or edges of the TRP array, e.g., from four corner sub-arrays. Thereby, the WTRU may determine a proper beam separation based on the four CSI-RS.

[[[[Determination Based on a Plurality of CSI-RS]]]]

The WTRU may determine a beam separation based on a plurality of received CSI-RS.

The WTRU may determine a plurality of directions, e.g., beam directions, based on the plurality of CSI-RS. Based on the plurality of directions, the WTRU may determine a beam separation, e.g., by determining a first beam separation in a first angular dimension and a second beam separation in a second angular dimension and determining a beam separation based on the first and second beam separations, e.g., as described above.

### [[[[Determination Based on RSRP]]]]

The WTRU may determine a beam separation based on an estimated RS received power (RSRP), wherein the RSRP may be estimated based on one or more received CSI-RS. For example, the WTRU may be configured with a mapping between a plurality of RSRP value ranges and a plurality of beam separations, e.g., a one-to-one mapping. The beam separations may for instance be given in degrees or rad.

The motivation for the RSRP-based approach may be that the network may know or determine the relationship between the WTRU-received RSRP and proper beam separation.

In some cases, the proper beam separation may also depend on the angle between the TRP array and the WTRU direction. Hence, it may be reasonable that the WTRU may be configured with a set of mappings between pluralities of RSRP value ranges and pluralities of beam separations, wherein a mapping from the set of mappings may be associated with an RS, e.g., a CSI-RS from a plurality of CSI-RS. For example, different CSI-RS may correspond to different angles between the TRP array and the direction of the WTRU. Hence, the WTRU receive the plurality of CSI-RS, measure corresponding RSRPs, select a CSI-RS, e.g., based on which CSI-RS that had the highest RSRP, and determine a beam separation based on the mapping associated with the selected CSI-RS and based on the RSRP of the selected CSI-RS.

### [[[Determination Based on Received CSI-RS and Indicated Beam Separation]]]

The WTRU may determine beam separation based on a combination of: beam separation determination based on received CSI-RS, e.g., one or more CSI-RS as described above; and beam separation determination based on indicated beam separation, e.g., as described above.

For example, the WTRU determines a first beam separation based on received CSI-RS, and transmits SRS based on the determined first beam separation. The network may receive the SRS and determine if a smaller or larger beam separation would be beneficial. Hence, the WTRU may receive an indication of beam separation, e.g., an indication of beam separation level adjustment. The WTRU may determine a second beam separation based on the first beam separation and the received indication. In other words, the received indication may adjust the beam separation, e.g., increase or decrease, in relation to the first beam separation that the WTRU determined based on the received CSI-RS.

The combination embodiment may be beneficial since it may mitigate initial SRS transmission with too high beam separation. Instead, the first beam separation based on a plurality of received CSI-RS may allow the WTRU to determine a beam separation that is roughly suitable, while subsequent received indication(s) may adjust the beam separation for subsequent SRS transmission(s).

The combination embodiment for beam separation determination may also be combined with a reception of a plurality of CSI-RS, e.g., for the initial beam separation determination, and subsequent one or more receptions of a single CSI-RS, e.g., for determining the reference direction of UL Tx beams for subsequent SRS transmission(s).

### [[WTRU Determines UL Tx Beams for SRS]]

### [[[General Description]]]

The WTRU may determine a set of UL Tx beams for a set of SRS, e.g., based on the received CSI-RS and the determined beam separation, wherein the set of SRS may comprise a configured set of SRS, an SRS transmission subset, etc.

In some cases, an UL Tx beam is determined for an SRS in the set of SRS, e.g., a one-to-one mapping. In some cases, an UL Tx beam is determined for multiple SRS in the set of SRS, e.g., a one-to-multiple mapping. In some cases, multiple UL Tx beams are determined for an SRS in the set of SRS, e.g., a multiple-to-one mapping. In some cases, a combination of one-to-one mapping, one-to-multiple mapping, and/or multiple-to-one mapping, are used between the determined set of UL Tx beams and the set of SRS.

In some cases, the WTRU may determine a first set of UL Tx beams for a first set of SRS, e.g., a configured set of SRS or an indicated SRS transmission subset. Furthermore, the WTRU may determine a second set of UL Tx beams for a second set of SRS, e.g., a determined SRS transmission subset. The determined set of UL Tx beams may refer to the first set of UL Tx beams and/or the second set of UL Tx beams.

The WTRU may have a limited capability of generating a number of different UL Tx beams for a reference direction and a beam separation. Hence, the procedure herein may result in that the set of UL Tx beams comprises one or more UL Tx beams that are the same, e.g., if the size of the set of UL Tx beams is to be the same as the set of SRS. Alternatively, the set of UL Tx beams may be determined so that there are no duplicated UL Tx beams in the set. Hence, the size of the set of UL Tx beams may be smaller than the set of SRS.

The WTRU may also take into account its capability of simultaneous UL transmission, as well as whether the set of SRS comprises simultaneously transmitted SRS, when determining the UL Tx beams.

### [[[UL Tx Beam(s) Determined Based Directly on Received CSI-RS]]]

In some cases, the set of UL Tx beams are directly based on one or more received CSI-RS. The one or more UL Tx beams may be determined regardless of the determined beam separation.

In some cases, the WTRU determines the set of UL Tx beams prior to the determination of the beam separation. For instance, the beam separation may be determined based on the determined UL Tx beams. The beam separation may correspond to the determined UL Tx beams.

For example, the UL Tx beam for an SRS may be determined using a CSI-RS as spatial reference. For example, the UL Tx beam for the SRS is determined based on the Rx beam that the WTRU determined for CSI-RS reception and beam correspondence. In another example, the UL Tx beam(s), e.g., precoders, for one or more SRS may be determined based on the one or more CSI-RS and DL/UL reciprocity, wherein the number of SRS may be the same as the number of CSI-RS.

### [[[UL Tx Beam(s) Determined Based on Beam Separation]]]

In some cases, the set of UL Tx beams are based on one or more received CSI-RS and a determined beam separation. The one or more received CSI-RS might not be used to directly determine WTRU Tx beam(s) for one or more SRS, as described above. Instead, the one or more received CSI-RS may be used to determine a beam separation, and/or one or more reference direction(s) towards a TRP array, etc. For example, the WTRU may determine a reference direction (e.g., towards a TRP array) based on a single received CSI-RS. The WTRU may determine the set of UL Tx beams such that a determined beam separation in the direction of the determined reference direction is fulfilled for the determined set of UL Tx beams.

In some cases, the determined beam separation may correspond to a range of beam separations, e.g., if the determined beam separation is larger or smaller than a previous beam separation. In this case, the WTRU may determine UL Tx beams such that the resulting beam separation falls within the determined range of beam separations.

In general, the WTRU may determine UL Tx beams prior to, jointly with, or after, the beam separation is determined. If the UL Tx beams are determined after the beam separation, the determined beam separation may correspond to a range of beam separations, such that there is some room to determine the set of UL Tx beam based on WTRU implementation constraints, which might not allow for complete flexibility of UL Tx beam selection.

### [[[Some UL Tx Beam(s) Determined Based Directly on Received CSI-RS and Some UL Tx Beam(s) Determined Based on Beam Separation]]]

The set of UL Tx beams may comprise a first subset and a second subset, for which the UL Tx beam determination differs. For instance, the first subset may be determined directly from the received CSI-RS, e.g., based on beam correspondence or reciprocity, and the second subset may be determined to satisfy the determined beam separation for the whole set of UL Tx beams. The size of the first subset may for instance be the same as a number of received CSI-RS, e.g., 1, 2, or 4.

In other words, the first subset of the set of UL Tx beams may be directly based on one or more received CSI-RS, as described above. For the remaining UL Tx beams, e.g., a second subset in the set of UL Tx beams, the UL Tx beams may be based on the one or more received CSI-RS, the determined beam separation, and the first subset of UL Tx beams. For example, the WTRU may determine the second subset of UL Tx beams such that the determined beam separation in the direction of the determined reference direction is fulfilled for the determined set of UL Tx beams.

In some cases, the first subset of the set of UL Tx beam may be determined such that the determined beam separation is fulfilled. The remaining UL Tx beams may be determined such that they do not, at least substantially, alter the beam separation of the set of UL Tx beams. For instance, the remaining UL Tx beams may be determined based on interpolation, e.g., in angle or direction, between the first subset of UL Tx beams.

### [[[Mapping Between UL Tx Beams and SRS]]]

The WTRU may determine a mapping between determine UL Tx beams and the SRS in the set of SRS.

The mapping may be based on the spatial properties of the UL Tx beams, e.g., the directions corresponding to the UL Tx beams.

The WTRU may determine an order among the UL Tx beams along an angular dimension, wherein the first UL Tx beam corresponds to the lowest angle in the angular dimension and the last UL Tx beam, among the ordered UL Tx beams, corresponds to the highest angle.

The WTRU may determine an order among the UL Tx beams based on two angular dimensions. For example, a first UL Tx beam may have a lower, same or higher angle in a first angular dimension than a second UL Tx beam, and a lower, same or higher angle in a second angular dimension than the second UL Tx beam. If the first and second UL Tx beams are different, they may differ in at least one or the angular dimensions. The angular dimensions may be determined by the WTRU, e.g., autonomously, or based on received CSI-RS.

For example, if the WTRU receives a plurality of CSI-RS the corresponding direction may be used to determine the two angular dimensions. In the example of two received CSI-RS, the two corresponding angles may be in a first angular dimension.

For instance, if the two CSI-RS are transmitted from edge sub-arrays in a linear array, the linear array would correspond to the first angular dimension. The second angular dimension may be orthogonal to the first angular dimension.

In the example of four received CSI-RS, the WTRU may determine a first angular dimension by assuming, e.g., based on a corresponding configuration, that two pairs of CSI-RS represent different angles in a first angular dimension. For instance, consider a first pair of CSI-RS that are transmitted from the upper left corner sub-array and upper right corner sub-array, respectively, of a planar TRP array, as well as a second pair of CSI-RS that are transmitted from the lower left corner sub-array and lower right corner sub-array, respectively. The angular difference, or the line, between the CSI-RS in the first pair and the angular difference, or the line, between the CSI-RS in the second pair may correspond to the first angular dimension. Similarly, the CSI-RS pair transmitted from upper left corner and the lower left corner, as well as the CSI-RS pair transmitted from the upper right corner and the lower right corner may correspond to the second angular dimension and may therefore be determined by the WTRU based on the received CSI-RS. Which CSI-RS pair(s) that correspond to the first angular dimension and which CSI-RS pair(s) that correspond to the second angular dimension may be configured to the WTRU or pre-defined, e.g., based on an order in a configured list of CSI-RS, or CSI-RS Id, corresponding to CSI-RS 1-4. For instance, the CSI-RS pairs in the first angular dimension may be {CSI-RS 1, CSI-RS 2} and {CSI-RS 3, CSI-RS 4}, whereas the CSI-RS pairs in the second angular dimension may be {CSI-RS 1, CSI-RS 3} and {CSI-RS 2, CSI-RS 4}. Other pairs may be equivalent. The angular dimensions may in general be orthogonal or non-orthogonal.

The WTRU may determine an order among the UL Tx beams by first considering the UL Tx beams with lowest angle in the first dimension. Among these, the UL Tx beam with lowest angle in the second dimension is ordered first. Then, the WTRU considers the UL Tx beams with second lowest angle in the first dimension, and orders them based on the angles in the second dimension. As an example, consider nine UL Tx beam with angles in a first and second dimension written as {angle in 1^{st} dimension, angle in 2^{nd} dimension}. The WTRU may determine an order as {15, 15}, {15, 30}, {15, 45}, {30, 15}, {30, 30}, {30, 45}, {45, 15}, {45, 30}, {45, 45}.

The WTRU may determine the mapping between the UL Tx beams and the SRS based on the determined order, e.g., mapping from first UL Tx beam to SRS with lowest Id, etc., wherein Id may correspond to SRS resource Id among all configured SRS or an SRS index within a set of SRS, such as an SRS resource set (e.g., index of SRS resource within the SRS resource set), or set of SRS antenna ports (e.g., SRS port index within set of SRS antenna ports), or similar.

A benefit of defining the mapping between angular dimensions, UL Tx beams and SRS is that the network may receive the SRS and determine, per angular dimension, if the beam separation should be adjusted. This is possible since both the network and WTRU know the relation between the UL Tx beams and the angular dimensions, and the mapping to SRS. The, the network may indicate to the WTRU a per angular dimension adjustment of beam separation, and the WTRU may subsequently adjust the beam separation in the corresponding angular dimension.

### [[WTRU Determines SRS Subset]]

### [[[Motivation]]]

A WTRU may be capable to generate only K different UL Tx beams corresponding to one or more particular received CSI-RS, and/or a particular beam separation, etc., as discussed above. For instance, the WTRU may be capable to generate the smallest beam separation, or beam separation level, with no more than two different UL Tx beams (K=2).

In the reference direction(s) given by the CSI-RS, the WTRU may be capable of a certain UL Tx beam resolution. Therefore, if K is less than the number of SRS in a configured set of SRS for transmission, or the number of SRS in an indicated SRS transmission subset, the WTRU might not be able to transmit the different SRS using different UL Tx beams. This may be handled by the WTRU by transmitting multiple SRS using the same UL Tx beam. However, the multiple SRS transmissions using the same UL Tx beam may be unnecessary, since they do not provide additional degrees of freedom. Instead, they use WTRU power and create unnecessary interference. Instead, the WTRU may determine an SRS subset, e.g., the determined SRS transmission subset, that can be transmitted using different UL Tx beams for different SRS in the subset. Note that the determined SRS subset, e.g., determined SRS transmission subset, may be a subset of an indicated SRS transmission subset, in case such a subset has been indicated to the WTRU.

### [[[Determination of SRS Subset]]]

The WTRU may determine an SRS subset, e.g., a determined SRS transmission subset, for instance based on one or more of: one or more WTRU capabilities, e.g., reported capabilities; one or more received CSI-RS; one or more configured set(s) of SRS; one or more received indication(s) of SRS transmission subset, e.g., indicated SRS transmission subset; one or more received indication(s) of beam separation; and/or a determined set of one or more UL Tx beams for SRS.

In some cases, the WTRU determines the SRS subset as a configured set of SRS. In some cases, the WTRU determines the SRS subset as an indicated SRS transmission subset.

In some cases, the WTRU determines the SRS subset as a set of SRS from multiple configured sets of SRS, e.g., SRS resource sets. The different configured sets of SRS may have different sizes, and the WTRU may select a set of SRS, e.g., based on its size, which may be equal to the number of different UL Tx beams.

In some cases, the WTRU may determine the SRS subset as a subset of a configured set of SRS. For example, if the number of different UL Tx beams in the determined set of UL Tx beams, e.g., the size of the set of UL Tx beams, is smaller than the configured set of SRS, the WTRU may determine the SRS subset as the number of different UL Tx beams. The WTRU may select SRS from a configured set of SRS for inclusion in the SRS subset based on one or more of the rules described above, e.g., based on SRS Ids, SRS time domain properties, etc.

The WTRU may take into account its capability of simultaneous UL transmission, the determined set of UL Tx beams, and/or whether the set of SRS comprises simultaneously transmitted SRS, when determining the SRS subset. For example, the WTRU may omit a first SRS from the determined subset since it is simultaneous with a second SRS that is included in the determined subset, since the WTRU might not be capable to transmit the corresponding UL Tx beams simultaneously. Note that the mapping between UL Tx beams to SRS may be up to the WTRU to determine, which means that the WTRU, at least to some extent, may avoid assigning UL Tx beams to simultaneous SRS that cannot be simultaneously transmitted. Otherwise, the WTRU may omit a corresponding SRS from the determined subset, and thereby potentially also the corresponding UL Tx beam.

Following the same method as above, the WTRU may determine the SRS subset, e.g., determined SRS transmission subset, as a subset of an indicated SRS transmission subset.

### [[WTRU Reports SRS Subset]]

Upon determination of an SRS subset, e.g., the determined SRS transmission subset, the WTRU may report the subset, or related parameter, to the network, e.g., in an uplink control information (UCI), MAC CE, or similar, which may be carried in an UL channel such as PUCCH or PUSCH.

For instance, the WTRU may report the size of the subset. It may be useful for the network to learn of the size, so that the network may subsequently trigger transmission of a corresponding number of SRS.

Alternatively, the WTRU may report the maximum number of different UL Tx beams, e.g., for a beam separation, and/or reference direction, etc., such as the indicated or determined beam separation, determined reference direction based on received CSI-RS, etc.

The WTRU may also report how many different UL Tx beams of the reported number of UL Tx beams that the WTRU can transmit simultaneously. Alternatively, the WTRU may also report how many different SRS transmission occasions, e.g., with equal number of SRS per occasion, that the WTRU would require to transmit the reported subset.

### [[WTRU Transmits SRS]]

The WTRU may transmit, and/or the network may receive, one or more SRS, for instance an indicated SRS transmission subset, a determined SRS transmission subset, and/or a configured set of SRS. The WTRU may transmit the SRS using the corresponding determined UL Tx beam(s) that may correspond to a determined beam separation.

Based on the received SRS, the network may determine if the corresponding beam separation was proper, too small, or too large. For instance, the network may determine the received SRS powers in different sub-arrays and thereby determine if the main lobe of each SRS is received within the array our outside the array. Alternatively, the network may determine a corresponding maximum rank or spectral efficiency based on the received SRS. The network may iteratively estimate if the beam separation is too small/large, indicate to the WTRU to increase/decrease the beam separation, etc., until beams with a proper beam separation are received.

### [Exemplary Embodiments]

### [[Dynamic Adaptation of SRS Beam Separation]]

### [[[Summary]]]

In this embodiment, the WTRU determines the direction towards the TRP array based on a single CSI-RS. The WTRU transmits an indicated subset of SRS in the direction of the TRP array using a corresponding set of UL Tx beams that correspond to a beam separation. The network may determine if the beam separation that the WTRU used was too small, too large, or proper, e.g., based on maximizing the degree-of-freedom in a near-field line-of-sight UL channel. Hence, the WTRU may receive an indication from the network to increase, decrease, or maintain, the beam separation. Based on the beam separation indication, the WTRU may change the UL Tx beams in order to increase or decrease the beam separation, for a subsequent transmission of a subsequently indicated subset of SRS.

### [[[WTRU Actions]]]

A WTRU may:

Receive a configuration of a CSI-RS resource, a set of SRS resources, a spatial relation between a single CSI-RS and the set(s) of SRS resource, etc.;

Receive the single CSI-RS resource;

Receive an indication to transmit a first subset (of size N1) of the SRS resources with a first beam separation level: e.g., the first subset comprises two SRS resources (N1=2). The indication may for example comprise N1 or a subset index; e.g., the first beam separation level may be the lowest, which may correspond to the lowest beam separation of the N SRS resources supported by the WTRU capability;

Determine a first set of (N1) SRS Tx beams for the first subset of SRS resources, based on the first beam separation level and the received CSI-RS;

Transmit the first subset of SRS resources using the determined first set of SRS Tx beams, corresponding to the first beam separation level;

Receive an indication to transmit a second subset (of size N2) of the SRS resources with a second beam separation level: e.g., the indication of the second beam separation level may comprise and increase/decrease, step size, or absolute beam separation level, which may be based on WTRU capability;

Determine a second set of SRS Tx beams for the second subset of SRS resources, based on the indicated second beam separation level and the received CSI-RS;

Transmit the second subset of SRS resources using the determined second set of SRS Tx beams, corresponding to the second beam separation level.

### [[[Network Actions]]]

A network (node) may:

Transmit a configuration of a CSI-RS resource, a set of SRS resources, a spatial relation between the single CSI-RS and the set(s) of SRS resource, etc.;

Transmit the single CSI-RS resource;

Transmit an indication to transmit a first subset (of size N1) of the SRS resources with a first beam separation level. E.g., the first subset comprises two SRS resources (N1=2). The indication may for example comprise N1 or a subset index. E.g., the first beam separation level may be the lowest, which may correspond to the lowest beam separation of the N SRS resources;

Receive the first subset of SRS resources;

Determine whether the first beam separation level needs to be adjusted, based on the received first subset of SRS resources, thereby obtaining a second beam separation level;

Determine a second subset of SRS resources, the received first subset of SRS resources and the determined second beam separation level;

Transmit an indication to transmit the second subset (of size N2) of the SRS resources with the second beam separation level. E.g., the indication of the second beam separation level may comprise and increase/decrease, step size, or absolute beam separation level; and

Receive the second subset of SRS resources with the second beam separation level.

### [[WTRU-Determined Subsets of SRS Resources for Transmission]]

### [[[Summary]]]

Different sizes of the subset of SRS may be applicable for different beam separations. For instance, for a small beam separation, the WTRU may be capable of generating only a small number of corresponding UL Tx beams. Therefore, the subset of SRS may be small in this case. On the other hand, the WTRU may be able to generate a larger number of different UL Tx beams that correspond to a larger beam separation. Therefore, the embodiment also includes the WTRU determination of the subset of SRS resources, based on the beam separation and the direction, as estimated from the CSI-RS.

### [[[WTRU Actions]]]

A WTRU may:

Receive a configuration of a CSI-RS resource, a set of SRS resources, a spatial relation between a single CSI-RS and the set(s) of SRS resource, etc.;

Receive the single CSI-RS resource;

Receive an indication to transmit the set of SRS resources with a first beam separation, e.g., the first beam separation may correspond to a lowest beam separation;

Determine a first subset of SRS resources and a corresponding first set of SRS Tx beams, based on the first beam separation and the received CSI-RS. Consider the example that the set of SRS resources comprises 8 SRS resources. Due to the WTRU capability, the WTRU can only generate 2 different SRS Tx beams for the first beam separation. Therefore, the WTRU determines the first subset of SRS resources to comprise only 2 SRS resources;

Transmit the first subset of SRS resources using the determined first set of SRS Tx beams;

Receive an indication to transmit the set of SRS resources with a second beam separation;

Determine a second subset of SRS resources and a corresponding second set of SRS Tx beams, based on the second beam separation and the received CSI-RS. Again, consider the example that the set of SRS resources comprises 8 SRS resources. Due to the WTRU capability, the WTRU can generate 6 different SRS Tx beams for the second beam separation. Therefore, the WTRU determines the second subset of SRS resources to comprise 6 SRS resources;

Transmit the second subset of SRS resources using the determined second set of SRS Tx beams, corresponding to the second beam separation.

### [[WTRU Reporting of Max Number of SRS Resources for a Beam Separation]]

In this embodiment, the WTRU determines how many UL Tx Beams it can generate for a given reference direction (given by the CSI-RS) and a beam separation. The WTRU reports this number to the network.

### [[[WTRU Actions]]]

A WTRU may:

Receive a configuration of a CSI-RS resource, a set of SRS resources, a spatial relation between a single CSI-RS and the set(s) of SRS resource, etc.;

Receive the single CSI-RS resource;

Receive a trigger to report a maximum number of SRS resources that can be transmitted with different UL Tx beams for a first beam separation and the CSI-RS, e.g., the first beam separation may correspond to a default beam separation, an indicated beam separation (as in example embodiments 1), a beam separation determined from a plurality of CSI-RS (e.g., as in example embodiment 4), etc.;

Determine a maximum number of SRS resources, based on the first beam separation and the received CSI-RS. Consider the example that the set of SRS resources comprises 8 SRS resources. Due to the WTRU capability, the WTRU can only generate 2 different SRS Tx beams for the first beam separation. Therefore, the WTRU determines the maximum number of SRS resources as 2;

Report the determined maximum number of SRS resources;

Receives an indication to transmit a subset of SRS resources with the first beam separation. The subset may comprise up to the reported maximum number of SRS resources, e.g., 2;

Determine a set of SRS Tx beams, based on the first beam separation and the received CSI-RS; and

Transmit the subset of SRS resources using the determined set of SRS Tx beams.

### [[WTRU-Determined Beam Separation]]

### [[[Summary]]]

In this embodiment, the WTRU determines a direction based on a first CSI-RS and a beam separation based on, e.g., two other CSI-RS (2nd and 3rd), wherein the first CSI-RS may be transmitted more frequently than the two other CSI-RS.

### [[[WTRU Actions]]]

A WTRU may:

Receive a configuration of a first CSI-RS and a plurality (e.g., a 2nd and a 3rd) of CSI-RS, a set of SRS resources, etc.;

Receive the first CSI-RS;

Receive a configuration/activation/indication to transmit the set of SRS resources with a beam separation based on the plurality of CSI-RS;

Receive the plurality of CSI-RS. For example, the plurality of CSI-RS are transmitted from the TRP edge sub-arrays;

Determine a beam separation based on the plurality of CSI-RS;

Receive the first CSI-RS. For example, the first CSI-RS is transmitted from the TRP center sub-array. The first CSI-RS may be received more frequently than the plurality of CSI-RS;

Determine a set of SRS Tx beams based on the determined beam separation and the first CSI-RS; and

Transmit the set of SRS resources using the determined set of SRS Tx beams.

### [[WTRU Reporting of Max Number of SRS Resources for a Beam Separation Determined From CSI-RS]]

### [[[Summary]]]

In this embodiment, the WTRU determines how many different UL Tx beams it can generate for a given beam separation, as determined by a plurality of CSI-RS. The WTRU reports this number to the network.

### [[[WTRU Actions]]]

A WTRU may:

Receive a configuration of a plurality of CSI-RS resources, etc.;

Receive the plurality of CSI-RS resources;

Receive a trigger to report a maximum number of SRS resources that can be transmitted with different UL Tx beams for a beam separation determined from the CSI-RS;

Determine a beam separation based on the received plurality of CSI-RS. The received CSI-RS may also be indicative of the direction of the corresponding SRS Tx beams;

Determine the maximum number of SRS resources, based on the received CSI-RS and the determined beam separation. For example, due to its capability, the WTRU can only generate 4 different SRS Tx beams with the determined beam separation in the directions given by the CSI-RS; and

Report the determined maximum number of SRS resources.

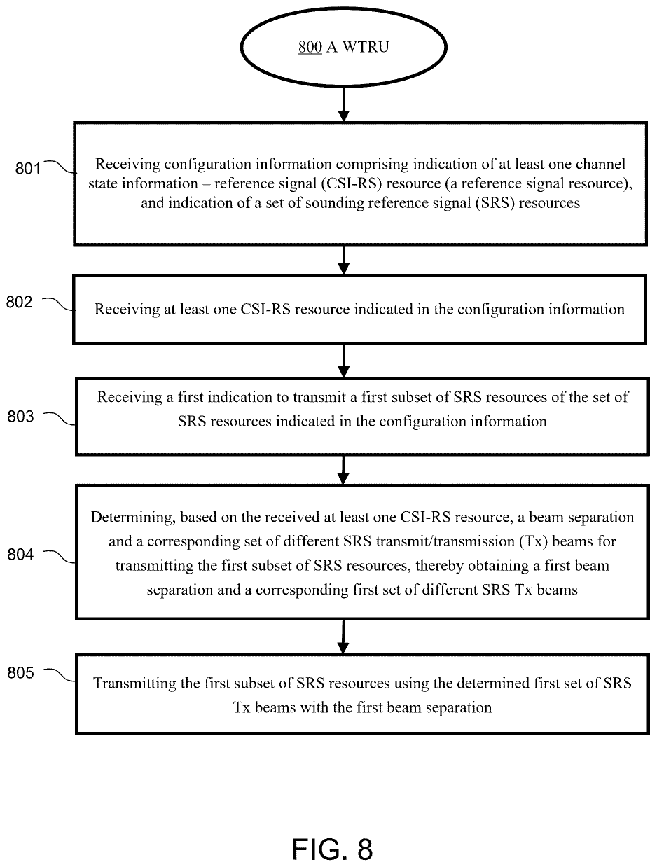

FIG. 8 is a flow chart of a method according to an embodiment, implemented by a WTRU. The method 800 may comprise:
receiving (801) configuration information comprising indication of at least one channel state information-reference signal (CSI-RS) resource (a reference signal resource), and indication of a set of sounding reference signal (SRS) resources;
receiving (802) at least one CSI-RS resource indicated in the configuration information;
receiving (803) a first indication to transmit a first subset of SRS resources of the set of SRS resources indicated in the configuration information;
determining (804), based on the received at least one CSI-RS resource, a beam separation and a corresponding set of different SRS transmit/transmission (Tx) beams for transmitting the first subset of SRS resources, thereby obtaining a first beam separation and a corresponding first set of different SRS Tx beams; and
transmitting (805) the first subset of SRS resources using the determined first set of SRS Tx beams with the first beam separation.

According to an embodiment of the method, the beam separation corresponds to a maximum, minimum or mean angular difference between angles of main radio wave lobes of the corresponding set of different SRS Tx beams.

According to an embodiment of the method, receiving at least one CSI-RS resource comprises receiving at least two CSI-RS resources, and determining the beam separation and the corresponding set of different SRS Tx beams for transmitting the first subset of SRS resources is based on the received at least two CSI-RS resources.

According to an embodiment of the method, the first subset of SRS resources may comprise more SRS resources than the number of received CSI-RS resources, and wherein for determining the first beam separation and the corresponding first set of SRS Tx beams, the WTRU first determines an SRS Tx beam for each of the at least two received CSI-RS resources, thereby obtaining a subset of SRS Tx beams, such that the subset of SRS Tx beams correspond to (have) the first beam separation.

According to an embodiment of the method, receiving the at least one CSI-RS resource comprises receiving a single CSI-RS resource, and wherein, following the transmitting the first subset of SRS resources, the method may comprise:
receiving a second indication to transmit, with a second beam separation different from the first beam separation, a second subset of SRS resources of the set of SRS resources indicated in the configuration information, the second indication comprising an indication of the second beam separation;
determining the second beam separation and a corresponding second set of different SRS Tx beams for transmitting the second subset of SRS resources, based on the received single CSI-RS resource; and
transmitting the second subset of SRS resources using the determined second set of SRS Tx beams with the second beam separation.

According to an embodiment of the method, the method comprises transmitting, by the WTRU, beam separation related capability information, comprising at least one of: support for beam separation; a supported number of beam separation levels; and wherein the indication of the second beam separation, comprised in the second indication, is according to the beam separation related capability information.

According to an embodiment of the method, the indication of the second beam separation comprises one of: an absolute beam separation level; and beam separation level increase or decrease.

There is also disclosed and described a wireless transmit-receive unit (WTRU) (e.g., that communicates with a network node), comprising at least one processor configured to:
receive configuration information comprising indication of at least one channel state information-reference signal (CSI-RS) resource, and indication of a set of sounding reference signal (SRS) resources;
receive at least one CSI-RS resource indicated in the configuration information;
receive a first indication to transmit a first subset of SRS resources of the set of SRS resources indicated in the configuration information;
determine, based on the received at least one CSI-RS resource, a beam separation and a corresponding set of different SRS Tx beams for transmitting the first subset of SRS resources, thereby obtaining a first beam separation and a corresponding first set of different SRS Tx beams; and
transmit the first subset of SRS resources using the determined first set of SRS Tx beams with the first beam separation.

According to an embodiment of the WTRU, the beam separation corresponds to a maximum, minimum or mean angular difference between angles of main radio wave lobes of the corresponding set of different SRS Tx beams.

According to an embodiment of the WTRU, receiving at least one CSI-RS resource comprises receiving at least two CSI-RS resources, and wherein determining the beam separation and the corresponding set of different SRS Tx beams for transmitting the first subset of SRS resources is based on the received at least two CSI-RS resources.

According to an embodiment of the WTRU, the first subset of SRS resources comprises more SRS resources than the number of received CSI-RS resources, and wherein for determining the first beam separation and the corresponding first set of SRS Tx beams, the at least one processor may be configured to first determine an SRS Tx beam for each of the at least two received CSI-RS resources, thereby obtaining a subset of SRS Tx beams, such that the subset of SRS Tx beams correspond to (have) the first beam separation.

According to an embodiment of the WTRU, receive the at least one CSI-RS resource may comprise receive a single CSI-RS resource, and wherein, following the transmission of the first subset of SRS resources, the at least one processor may be configured to:
receive a second indication to transmit, with a second beam separation different from the first beam separation, a second subset of SRS resources of the set of SRS resources indicated in the configuration information, the second indication comprising an indication of the second beam separation;
determine the second beam separation and a corresponding second set of different SRS Tx beams for transmitting the second subset of SRS resources, based on the received single CSI-RS resource; and
transmit the second subset of SRS resources using the determined second set of SRS Tx beams with the second beam separation.

According to an embodiment of the WTRU, the at least one processor may be configured to transmit beam separation related capability information, comprising at least one of: support for beam separation; a supported number of beam separation levels; and wherein the indication of the second beam separation, comprised in the second indication, is according to the beam separation related capability information.

According to an embodiment of the WTRU, the indication of the second beam separation may comprise one of: an absolute beam separation level; and beam separation level increase or decrease.

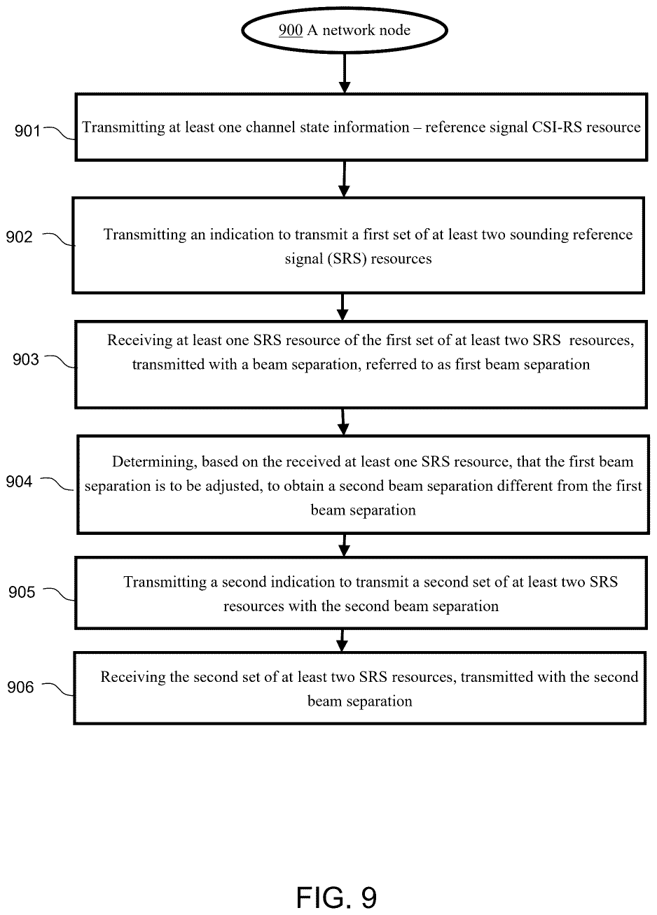

FIG. 9 is a flow chart of a method according to an embodiment, implemented by a network node (e.g., a Base Station (BS), a gNB, a TRP) that e.g., communicates with a WTRU. The method 900 may comprise:
transmitting (901) at least one channel state information-reference signal CSI-RS resource (a reference signal resource);
transmitting (902) an indication to transmit a first set of at least two sounding reference signal (SRS) resources;
receiving (903) at least one SRS resource of the first set of at least two SRS resources, transmitted with a beam separation, referred to as first beam separation;
determining (904), based on the received at least one SRS resource, that the first beam separation is to be adjusted, to obtain a second beam separation different from the first beam separation;
transmitting (905) a second indication to transmit a second set of at least two SRS resources with the second beam separation; and
receiving (906) the second set of at least two SRS resources, transmitted with the second beam separation.

According to an embodiment of the method, the beam separation corresponds to a maximum, minimum or mean angular difference between angles of main radio wave lobes with which the at least one SRS resource is received at the network node.

According to an embodiment of the method, the method may comprise receiving beam separation related capability information, comprising at least one of: support for beam separation; a supported number of beam separation levels; and wherein the indication of the second beam separation, comprised in the second indication, is according to the beam separation related capability information.

According to an embodiment of the method, the indication of the second beam separation may comprise one of: an absolute beam separation level; and a beam separation level increase or decrease.

There is also disclosed and described a network node, comprising at least one processor that may be configured to:
transmit at least one channel state information-reference signal (CSI-RS) resource;
transmit an indication to transmit a first set of at least two sounding reference signal (SRS) resources;
receive at least one SRS resource of the first set of at least two SRS resources, transmitted with a beam separation, referred to as first beam separation;
determine, based on the received at least one SRS resource, that the first beam separation is to be adjusted, to obtain a second beam separation different from the first beam separation;
transmit a second indication to transmit a second set of at least two SRS resources with the second beam separation; and
receive the second set of at least two SRS resources, transmitted with the second beam separation.

According to an embodiment of the network node, the beam separation corresponds to a maximum, minimum or mean angular difference between angles of main radio (Tx) wave lobes with which the at least one SRS resource is received at the network node.

According to an embodiment of the network node, the at least one processor may be configured to: receive beam separation related capability information, comprising at least one of: support for beam separation; a supported number of beam separation levels; and wherein the indication of the second beam separation, comprised in the second indication, is according to the beam separation related capability information.

According to an embodiment of the network node, the indication of the second beam separation comprises one of: an absolute beam separation level; and beam separation level increase or decrease.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a wireless transmit-receive unit (WTRU), comprising:
receiving configuration information comprising indication of at least one channel state information-reference signal (CSI-RS) resource, and indication of a set of sounding reference signal (SRS) resources;
receiving at least one CSI-RS resource indicated in the configuration information;
receiving a first indication to transmit a first subset of SRS resources of the set of SRS resources indicated in the configuration information;
determining, based on the received at least one CSI-RS resource, a beam separation and a corresponding set of different SRS Tx beams for transmitting the first subset of SRS resources, thereby obtaining a first beam separation and a corresponding first set of different SRS Tx beams; and
transmitting the first subset of SRS resources using the determined first set of SRS Tx beams with the first beam separation.

2. The method of claim 1, wherein the beam separation corresponds to a maximum, minimum or mean angular difference between angles of main radio wave lobes of the corresponding set of different SRS Tx beams.

3. The method of claim 1, wherein receiving at least one CSI-RS resource comprises receiving at least two CSI-RS resources, and wherein determining the beam separation and the corresponding set of different SRS Tx beams for transmitting the first subset of SRS resources is based on the received at least two CSI-RS resources.

4. The method of claim 3, wherein the first subset of SRS resources comprises more SRS resources than the number of received CSI-RS resources, and wherein for determining the first beam separation and the corresponding first set of SRS Tx beams, the WTRU first determines an SRS Tx beam for each of the at least two received CSI-RS resources, thereby obtaining a subset of SRS Tx beams, such that the subset of SRS Tx beams correspond to the first beam separation.

5. The method of claim 1, wherein receiving the at least one CSI-RS resource comprises receiving a single CSI-RS resource, and wherein, following the transmitting the first subset of SRS resources, the method comprises:
receiving a second indication to transmit, with a second beam separation different from the first beam separation, a second subset of SRS resources of the set of SRS resources indicated in the configuration information, the second indication comprising an indication of the second beam separation;
determining the second beam separation and a corresponding second set of different SRS Tx beams for transmitting the second subset of SRS resources, based on the received single CSI-RS resource; and
transmitting the second subset of SRS resources using the determined second set of SRS Tx beams with the second beam separation.

6. The method of claim 5, comprising transmitting, by the WTRU, beam separation related capability information, comprising at least one of: support for beam separation; a supported number of beam separation levels;
and wherein the indication of the second beam separation, comprised in the second indication, is according to the beam separation related capability information.

7. The method according to claim 6, wherein the indication of the second beam separation comprises one of: an absolute beam separation level; and beam separation level increase or decrease.

8. A wireless transmit-receive unit (WTRU), comprising at least one processor configured to:
receive configuration information comprising indication of at least one channel state information-reference signal (CSI-RS) resource, and indication of a set of sounding reference signal (SRS) resources;
receive at least one CSI-RS resource indicated in the configuration information;
receive a first indication to transmit a first subset of SRS resources of the set of SRS resources indicated in the configuration information;
determine, based on the received at least one CSI-RS resource, a beam separation and a corresponding set of different SRS Tx beams for transmitting the first subset of SRS resources, thereby obtaining a first beam separation and a corresponding first set of different SRS Tx beams; and
transmit the first subset of SRS resources using the determined first set of SRS Tx beams with the first beam separation.

9. The WTRU of claim 8, wherein the beam separation corresponds to a maximum, minimum or mean angular difference between angles of main radio wave lobes of the corresponding set of different SRS Tx beams.

10. The WTRU of claim 8, wherein receiving at least one CSI-RS resource comprises receiving at least two CSI-RS resources, and wherein determining the beam separation and the corresponding set of different SRS Tx beams for transmitting the first subset of SRS resources is based on the received at least two CSI-RS resources.

11. The WTRU of claim 10, wherein the first subset of SRS resources comprises more SRS resources than the number of received CSI-RS resources, and wherein for determining the first beam separation and the corresponding first set of SRS Tx beams, the at least one processor is configured to first determine an SRS Tx beam for each of the at least two received CSI-RS resources, thereby obtaining a subset of SRS Tx beams, such that the subset of SRS Tx beams correspond to the first beam separation.

12. The WTRU of claim 8, wherein receive the at least one CSI-RS resource comprises receive a single CSI-RS resource, and wherein, following the transmission of the first subset of SRS resources, the at least one processor is configured to:
receive a second indication to transmit, with a second beam separation different from the first beam separation, a second subset of SRS resources of the set of SRS resources indicated in the configuration information, the second indication comprising an indication of the second beam separation;
determine the second beam separation and a corresponding second set of different SRS Tx beams for transmitting the second subset of SRS resources, based on the received single CSI-RS resource; and
transmit the second subset of SRS resources using the determined second set of SRS Tx beams with the second beam separation.

13. The WTRU of claim 12, wherein the at least one processor is configured to transmit beam separation related capability information, comprising at least one of: support for beam separation; a supported number of beam separation levels;
and wherein the indication of the second beam separation, comprised in the second indication, is according to the beam separation related capability information.

14. The WTRU according to claim 13, wherein the indication of the second beam separation comprises one of: an absolute beam separation level; and beam separation level increase or decrease.

15. A method, implemented by a first network node, comprising:
transmitting at least one channel state information-reference signal CSI-RS resource;
transmitting an indication to transmit a first set of at least two sounding reference signal (SRS) resources;
receiving at least one SRS resource of the first set of at least two SRS resources, transmitted with a beam separation, referred to as first beam separation;
determining, based on the received at least one SRS resource, that the first beam separation is to be adjusted, to obtain a second beam separation different from the first beam separation;
transmitting a second indication to transmit a second set of at least two SRS resources with the second beam separation; and
receiving the second set of at least two SRS resources, transmitted with the second beam separation.

16. The method of claim 15, wherein the beam separation corresponds to a maximum, minimum or mean angular difference between angles of main radio wave lobes with which the at least one SRS resource is received at the network node.

17. The method of claim 15, comprising:
receiving beam separation related capability information, comprising at least one of: support for beam separation; a supported number of beam separation levels;
and wherein the indication of the second beam separation, comprised in the second indication, is according to the beam separation related capability information.

18. The method according to claim 17, wherein the indication of the second beam separation comprises one of: an absolute beam separation level; and beam separation level increase or decrease.
